(19) United States
(12) Patent Application Publication
(10) Pub. No.: US 2026/0331083 A1
(43) Pub. Date: Oct. 22, 2026

(54) APPARATUSES AND DEVICES FOR PRODUCING MUSICAL SOUNDS BY SIMULATING AN EXPERIENCE OF PLAYING MUSICAL INSTRUMENTS

(71) Applicant: Tejas Pradip Rode, Gilbert, AZ (US)

(72) Inventor: Tejas Pradip Rode, Gilbert, AZ (US)

(21) Appl. No.: 19/649,165

(22) Filed: Apr. 16, 2026

Related U.S. Application Data
(60) Provisional application No. 63/790,789, filed on Apr. 18, 2025.

(51) Int. Cl. G10H 1/00; G10H 1/32

(52) U.S. Cl. CPC G10H 1/0025; G10H 1/32

(57) ABSTRACT

An apparatus for producing musical sounds by simulating an experience of playing musical instruments, in accordance with some embodiments. Accordingly, the apparatus includes a body, a mechanical interface element, sensors, a processing device, a storage device, output devices, and feedback output devices. The mechanical interface element is configured to receive user actions from a user. The sensors are configured for detecting an operation associated with the mechanical interface element. The processing device is configured for generating sensor information, analyzing the sensor information, analyzing musical instrument information associated with a musical instrument, determining values of parameters associated with a musical sound production, synthesizing musical sounds, and determining a feedback for the operation. The storage device is configured for storing the musical instrument information. The output devices are configured for producing the musical sounds. The feedback output devices are configured for providing feedback to the user through the mechanical interface element.

### REFERENCE TO RELATED APPLICATIONS

This application claims the benefit of U.S. Provisional Patent Application No. 63/790,789, titled “APPARATUSES AND DEVICES FOR PRODUCING MUSICAL SOUNDS BY SIMULATING AN EXPERIENCE OF PLAYING MUSICAL INSTRUMENTS”, filed Apr. 18, 2025, which is incorporated by reference herein in its entirety.

### FIELD OF THE INVENTION

Generally, the present disclosure relates to the field of musical instruments. More specifically, the present disclosure relates to apparatuses and devices for producing musical sounds by simulating an experience of playing musical instruments.

### BACKGROUND OF THE INVENTION

Many acoustic musical instruments rely on a mechanically operated airflow source, such as a bellows or comparable airflow-generating mechanism, to drive one or more sound-generating elements. In free-reed keyboard instruments, for example, musical expression can depend not only on key selection but also on continuously varying airflow conditions created by user manipulation of the airflow mechanism. Such instruments may include structural components such as a body frame, keys, reeds, bellows structures, air passages, and related mechanical parts.

In some existing instruments and systems, physical airflow structures can contribute to weight, size, material constraints, manufacturing complexity, maintenance requirements, and variability in playing response. In some electronic musical devices, sound may be generated without reproducing the tactile feel and continuous expressive control associated with operation of a functional airflow mechanism. As a result, a user may not experience the resistance, pressure-related response, or dynamic interaction ordinarily associated with the corresponding acoustic instrument.

Existing musical devices are deficient with regard to several aspects. For instance, current musical devices that produce musical sounds using the bellows are clunky designs. As a result, different musical devices are needed that are compact in design. Moreover, current musical devices that do not use bellows deprive users of the experience of playing musical devices with bellows. As a result, different musical devices are needed that simulate the experience of playing the musical devices with the bellows.

Therefore, there is a need for apparatuses and devices for producing musical sounds by simulating an experience of playing musical instruments that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for producing musical sounds by simulating an experience of playing musical instruments, in accordance with some embodiments. Accordingly, the apparatus may include a body, a mechanical interface element, one or more sensors, a processing device, a storage device, one or more output devices, and one or more feedback output devices. Further, the mechanical interface element may be coupled to the body. Further, the mechanical interface element may be configured to receive one or more user actions from a user. Further, the one or more sensors may be coupled to the body. Further, the one or more sensors may be configured for detecting an operation associated with the mechanical interface element. Further, the operation may be based on the one or more user actions received by the mechanical interface element. Further, the processing device may be coupled to the body. Further, the processing device may be communicatively coupled with the one or more sensors. Further, the processing device may be configured for generating one or more sensor information based on the detecting of the operation. Further, the processing device may be configured for analyzing the one or more sensor information. Further, the processing device may be configured for analyzing one or more musical instrument information associated with a musical instrument. Further, the processing device may be configured for determining one or more values of one or more parameters associated with a musical sound production based on the analyzing of the one or more sensor information and the analyzing of the one or more musical instrument information. Further, the processing device may be configured for synthesizing one or more musical sounds based on the one or more values of the one or more parameters. Further, the processing device may be configured for determining a feedback for the operation based on the analyzing of the one or more sensor information and the one or more musical instrument information. Further, the storage device may be coupled to the body. Further, the storage device may be communicatively coupled with the processing device. Further, the storage device may be configured for storing the one or more musical instrument information associated with the musical instrument. Further, the one or more output devices may be coupled to the body. Further, the one or more output devices may be communicatively coupled with the processing device. Further, the one or more output devices may be configured for producing the one or more musical sounds based on the synthesizing of the one or more musical sounds. Further, the one or more feedback output devices may be coupled to the body. Further, the one or more feedback output devices may be communicatively coupled with the processing device. Further, the one or more feedback output devices may be configured for providing feedback to the user through the mechanical interface element based on the determining of the feedback.

Further disclosed herein is an apparatus for producing musical sounds by simulating an experience of playing musical instruments, in accordance with some embodiments. Accordingly, the apparatus may include a body, a mechanical interface element, one or more sensors, a processing device, a storage device, one or more output devices, and one or more feedback output devices. Further, the mechanical interface element may be coupled to the body. Further, the mechanical interface element may be configured to receive one or more user actions from a user. Further, the one or more sensors may be coupled to the body. Further, the one or more sensors may be configured for detecting an operation associated with the mechanical interface element. Further, the operation may be based on the one or more user actions received by the mechanical interface element. Further, the processing device may be coupled to the body. Further, the processing device may be communicatively coupled with the one or more sensors. Further, the processing device may be configured for generating one or more sensor information based on the detecting of the operation. Further, the processing device may be configured for analyzing the one or more sensor information. Further, the processing device may be configured for analyzing one or more musical instrument information associated with a musical instrument. Further, the processing device may be configured for determining one or more values of one or more parameters associated with a musical sound production based on the analyzing of the one or more sensor information and the analyzing of the one or more musical instrument information. Further, the processing device may be configured for synthesizing one or more musical sounds based on the one or more values of the one or more parameters. Further, the processing device may be configured for determining a feedback for the operation based on the analyzing of the one or more sensor information and the one or more musical instrument information. Further, the storage device may be coupled to the body. Further, the storage device may be communicatively coupled with the processing device. Further, the storage device may be configured for storing the one or more musical instrument information associated with the musical instrument. Further, the one or more output devices may be coupled to the body. Further, the one or more output devices may be communicatively coupled with the processing device. Further, the one or more output devices may be configured for producing the one or more musical sounds based on the synthesizing of the one or more musical sounds. Further, the one or more feedback output devices may be coupled to the body. Further, the one or more feedback output devices may be communicatively coupled with the processing device. Further, the one or more feedback output devices may be configured for providing feedback to the user through the mechanical interface element based on the determining of the feedback. Further, the operation associated with the mechanical interface element may include a movement of the mechanical interface element in relation to the body. Further, the feedback provided to the user may include a resistance opposing the movement of the mechanical interface element. Further, the user applies the one or more user actions by performing the one or more user actions on the mechanical interface element using one or more hands of the user. Further, the resistance opposing the movement applies one or more counteractions on the one or more hands of the user during the performing of the one or more user actions.

Further disclosed herein is an apparatus for producing musical sounds by simulating an experience of playing musical instruments, in accordance with some embodiments. Accordingly, the apparatus may include a body, a mechanical interface element, one or more sensors, a processing device, a storage device, one or more output devices, and one or more feedback output devices. Further, the mechanical interface element may be coupled to the body. Further, the mechanical interface element may be configured to receive one or more user actions from a user. Further, the one or more sensors may be coupled to the body. Further, the one or more sensors may be configured for detecting an operation associated with the mechanical interface element. Further, the operation may be based on the one or more user actions received by the mechanical interface element. Further, the processing device may be coupled to the body. Further, the processing device may be communicatively coupled with the one or more sensors. Further, the processing device may be configured for generating one or more sensor information based on the detecting of the operation. Further, the processing device may be configured for analyzing the one or more sensor information. Further, the processing device may be configured for analyzing one or more musical instrument information associated with a musical instrument. Further, the processing device may be configured for determining one or more values of one or more parameters associated with a musical sound production based on the analyzing of the one or more sensor information and the analyzing of the one or more musical instrument information. Further, the processing device may be configured for synthesizing one or more musical sounds based on the one or more values of the one or more parameters. Further, the processing device may be configured for determining a feedback for the operation based on the analyzing of the one or more sensor information and the one or more musical instrument information. Further, the storage device may be coupled to the body. Further, the storage device may be communicatively coupled with the processing device. Further, the storage device may be configured for storing the one or more musical instrument information associated with the musical instrument. Further, the one or more output devices may be coupled to the body. Further, the one or more output devices may be communicatively coupled with the processing device. Further, the one or more output devices may be configured for producing the one or more musical sounds based on the synthesizing of the one or more musical sounds. Further, the one or more feedback output devices may be coupled to the body. Further, the one or more feedback output devices may be communicatively coupled with the processing device. Further, the one or more feedback output devices may be configured for providing feedback to the user through the mechanical interface element based on the determining of the feedback. Further, the operation associated with the mechanical interface element may include a movement of the mechanical interface element in relation to the body. Further, the feedback provided to the user may include a resistance opposing the movement of the mechanical interface element. Further, the one or more feedback output devices comprise one or more first magnets, one or more second magnets, one or more actuators, and a magnet control device. Further, the one or more first magnets may be attached to one or more locations of the mechanical interface element. Further, the one or more actuators may be coupled to the body. Further, the one or more second magnets may be mechanically coupled to the one or more actuators. Further, the magnet control device may be operatively coupled with the one or more actuators. Further, the magnet control device may be communicatively coupled with the processing device. Further, the magnet control device may be configured for generating one or more control signals for the one or more actuators based on the determining of the feedback. Further, the one or more actuators may be configured for transitioning the one or more second magnets to one or more of a position from a plurality of positions and an orientation from a plurality of orientations based on the one or more control signals. Further, the one or more second magnets magnetically interface with the one or more first magnets based on the movement of the mechanical interface element. Further, one or more of the position and the orientation define a relative magnetic polarity and a relative generated magnetic force between the one or more second magnets and the one or more first magnets during the magnetic interfacing. Further, the resistance to the movement may be produced based on the relative magnetic polarity and the relative generated magnetic force.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a left side top perspective view of an apparatus 100 for producing musical sounds by simulating an experience of playing musical instruments, in accordance with some embodiments.

FIG. 2 is a left side top perspective view of the apparatus 100 with the one or more input devices 208, in accordance with some embodiments.

FIG. 3 is a left side top perspective view of the apparatus 100 with the one or more user input devices 302, in accordance with some embodiments.

FIG. 4 is a left side top perspective view of the apparatus 100 with the timing device 410, in accordance with some embodiments.

FIG. 5 is a left side top perspective view of the apparatus 100 with the one or more additional sensors 502, in accordance with some embodiments.

FIG. 6 is a left side top perspective view of the apparatus 100 with the one or more elastic elements 602 and the one or more elasticity control devices 604 of the one or more feedback output devices 114, in accordance with some embodiments.

FIG. 7 is a left side top perspective view of the apparatus 100 with the one or more conductive elements 702, the one or more magnetic field sources 704, and the one or more control devices 706 of the one or more feedback output devices 114, in accordance with some embodiments.

FIG. 8 is a left side top perspective view of the apparatus 100 with the one or more muscle stimulation electrodes 802 and the one or more stimulation control devices 804 of the one or more feedback output devices 114, in accordance with some embodiments.

FIG. 9 is a left side top perspective view of the apparatus 100 with the one or more environment sensors 902, in accordance with some embodiments.

FIG. 10 is a left side top perspective view of the apparatus 100 with the user output device 1002 and the user input device 1004, in accordance with some embodiments.

FIG. 11 is a top perspective view of the apparatus 100, in accordance with some embodiments.

FIG. 12 is a front perspective view of the apparatus 100, in accordance with some embodiments.

FIG. 13 is a rear left-side perspective view of the apparatus 100, in accordance with some embodiments.

FIG. 14 is a rear right-side perspective view of the apparatus 100, in accordance with some embodiments.

FIG. 15 is a block diagram of a device 1500 for producing musical sounds by simulating an experience of playing musical instruments, in accordance with some embodiments.

FIG. 16 is a block diagram of the device 1500 comprising one or more user input devices 1602, in accordance with some embodiments.

FIG. 17 is a block diagram of the device 1500 comprising one or more timing devices 1702, in accordance with some embodiments.

FIG. 18 is a block diagram of the device 1500 comprising one or more input devices 1802, in accordance with some embodiments.

FIG. 19 is a left side top perspective view of an apparatus 1900 for producing musical sounds by simulating an experience of playing musical instruments, in accordance with some embodiments.

FIG. 20 is a left side top perspective view of an apparatus 2000 for producing musical sounds by simulating an experience of playing musical instruments, in accordance with some embodiments.

FIG. 21 is an illustration of an online platform consistent with various embodiments of the present disclosure.

FIG. 22 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of producing musical sounds by simulating an experience of playing musical instruments, embodiments of the present disclosure are not limited to use only in this context.

In general, the method disclosed herein may be performed by one or more computing devices. For example, in some embodiments, the method may be performed by a server computer and/or a computing device in communication with one or more client devices over a communication network such as, for example, the Internet. In some other embodiments, the method may be performed by one or more of at least one server computer, at least one computing device, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer and/or the computing device may be and/or may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the processing device may be and/or may include a processor, a processing unit, a microprocessor, a microcontroller, etc. Further, the server computer and/or the computing device may be and/or may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the communication device may be and/or may include a communication interface, a network interface, etc. Further, the server computer and/or the computing device may be and/or may include may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on. Further, the storage device may be and/or may include a memory. Further, the user as defined herein may refer to a human, an animal, or an artificially intelligent being in any state of existence, unless stated otherwise, elsewhere in the present disclosure.

### Overview

The present disclosure describes apparatuses and devices for producing musical sounds by simulating an experience of playing musical instruments. Further, the present disclosure describes virtual bellows for an acoustic instrument.

Further, the present disclosure describes a musical device that replaces the airflow device with a mechanism that detects movement of the flap of the bellows using a sensor (e.g., accelerometer) and uses this information to programmatically influence the generation of the musical sounds. The bellows in the musical device are non-functional in that they need not produce any airflow but may offer a comparable user experience (e.g., resistance to movement of the flap as in the functional bellows, using moving magnets).

Further, the musical device imitates the bellow sound and bellow feel, without actually using air. Further, the musical device simulates the experience of playing an acoustic instrument that has a mechanism that creates airflow. Further, the musical device has a body frame (instrument body frame) comprised of polycarbonate, and a keyboard that is disposed on the body frame. Further, the keyboard may include an instrument keyboard. Further, the instrument keyboard structurally replicates a keyboard of the musical instrument.

Further, the musical device includes an accelerometer on an outer side of the bellow, which is the outer side, to detect the angle. Further, the moving of the bellows changes the angle. Further, the change in the angle is used to create a virtual air for producing musical sounds using the musical device.

Further, the musical device does not have any air flowing through it, but still, the user playing the musical device feels the air pressure on the bellows, as if the air is being filled into the musical device. This simulates the experience of playing a musical instrument with bellows that are operational and functional.

Further, the musical device has the following advantages: reduction of weight, reduction of size, the possibility of using different materials, the possibility of using different designs, conservation of natural materials like wood and leather, reduction of workload on instrument makers, making the instrument more accessible, making the instrument more technologically advanced, and ease of building.

Further, the musical device allows customization during play as it allows the user to set certain parameters, such as how much air pressure corresponds to the virtual air pressure that is generated when the bellow is moved three times.

Further, the musical device is an airless bellows-operated harmonium. Further, the musical device may be a perfectly tuned, customizable tuning harmonium, an easy-to-build harmonium, or an easy-to-carry harmonium.

Further, the musical device is an electronic harmonium, a retrofitted harmonium, an augmented harmonium, a harmonium synthesizer, a hybrid harmonium, and an electro-acoustic harmonium.

Further, the musical device synthesizes musical sound merely and does not use sampled (pre-recorded) sound. The musical sound may be created from scratch using acoustic modeling of reeds, making it fully customizable before and while playing the musical device.

Further, the musical device may include a user interface for enabling user interactions for modifying musical device (harmonium) settings. Further, the user interface and the user interactions are minimal. In most practical situations, there is no need to modify the musical device settings.

Further, the musical device allows adjusting audio characteristics of the musical sound produced by the musical device depending on other instruments or music being played in the environment of the musical device, to make the musical device sound balanced in any environment. Further, the musical device allows automatic adjustment of the audio characteristics of the musical sound produced by the musical device depending on other instruments or music being played in the environment.

Further, the musical device uses a microcontroller that results in very low latency in the musical sound generation after detecting the key presses.

Further, the musical device provides reed combination customization. Further, the reed combination customization gives the musician the ability to use a particular combination that is suitable for a performance, especially when accompanying a vocalist.

Further, the present disclosure describes a device for producing musical sounds by simulating an experience of playing musical instruments. Further, the device may be and/or may include a musical device, an apparatus (musical apparatus), an instrument (musical instrument), etc. Further, the device may include a reed instrument such as a harmonium, a dual reed harmonium, an accordion, a melodeon, a concertina, a bandoneon, a bagpipe, etc. Further, the device may include a pipe instrument such as a pipe organ, a positive organ, a portative organ, etc. Further, the device may include a mechanical instrument such as a calliope, a mechanical organ, a fairground organ, an orchestrion, etc. Further, the device replicates a form, a structure, etc., of the reed instrument, the pipe instrument, the mechanical instrument, etc. Further, the device may include one or more sensors that may be configured for detecting an operation associated with a mechanical interface (i.e., mechanical interface element) of an instrument (i.e., musical instrument). Further, the mechanical interface may include a flap, a panel, a hand paddle, a foot paddle, a strap, a handle, etc. Further, the mechanical interface may be interfaceable by the user, and at least a body part (such as a hand, a foot, etc.) of the user. Further, the operation may be based on a user action of a user received by the mechanical interface. Further, the user action may include a pulling action, a pushing action, a pumping action, a tilting action, a pressing action, a gesture, etc. Further, the device may include a processing device communicatively coupled with the one or more sensors. Further, the processing device may include a computing device, a processing unit, a processor, a microprocessor, a microcontroller, etc. Further, the processing device may be configured for obtaining one or more sensor information associated with the operation from the one or more sensors based on the detecting of the operation. Further, the operation corresponds to a generation of virtual air. Further, the operation and the virtual air are not actively involved in the production of musical sound through the instrument. Further, the instrument does not include any sound producing mechanisms (such as reeds), airflow generating mechanisms (functional bellows), etc., for producing the musical sounds. Further, the obtaining of the one or more sensor information may include generating the one or more sensor information. Further, the processing device may be configured for analyzing the one or more sensor information and one or more musical instrument information associated with a musical instrument. Further, the musical instrument may include the reed instrument, the pipe instrument, the mechanical instrument, etc. Further, the device simulates the experience of playing the musical instrument. Further, the processing device may be configured for determining one or more values of one or more parameters associated with a musical sound production based on the analyzing of the one or more sensor information and the one or more musical instrument information. Further, the one or more parameters may include volume, timbre, attack time, decay characteristic, pitch stability, etc. Further, the one or more parameters may include a pitch, a tone, a timbre, a frequency, a waveform, a harmonics, a volume, a musical note, etc. Further, the processing device may be configured for synthesizing one or more musical sounds based on the one or more values of the one or more parameters. Further, the processing device may be configured for determining a feedback for the operation based on the analyzing of the one or more sensor information and the one or more musical instrument information. Further, the feedback may be associated with the user action. Further, the feedback may be a response, a reaction, etc., to the user action. Further, the feedback may include a mechanical feedback, a haptic feedback, an auditory feedback, a visual feedback, etc. Further, the device may include a storage device communicatively coupled with the processing device. Further, the storage device may include a computing device. Further, the storage device may include a memory. Further, the storage device may be configured for storing the one or more musical instrument information associated with the musical instrument. Further, the storage device may be configured for storing the one or more sensor information. Further, the device may include one or more output devices operatively coupled with the processing device. Further, the one or more output devices may be configured for producing the one or more musical sounds based on the synthesizing of the one or more musical sounds. Further, the device may include one or more feedback output devices operatively coupled with the processing device. Further, the one or more feedback output devices may be configured for providing the feedback to the user based on the determining of the feedback. Further, the user experiences the playing of the musical instrument based on the user action of the user, the feedback provided to the user, and the producing of the one or more musical sounds. Further, the one or more feedback output devices produce the feedback on the mechanical interface. Further, the one or more feedback output devices may include speakers, etc.

In some embodiments, the analyzing of the one or more sensor information and the one or more musical instrument information may include analyzing the one or more sensor information and the one or more musical instrument information using one or more machine learning models. Further, the one or more machine learning models may be trained using one or more training data. Further, each of the one or more training data describes one or more musical instrument characteristics of each of one or more musical instruments.

In some embodiments, the instrument replicates a form of the musical instrument. Further, the form may include a shape, a size, an appearance, etc. Further, the mechanical interface replicates one or more of a form and a motion of a functional mechanical interface of the musical instrument. Further, the motion may include a pushing motion, a pulling motion, a squeezing motion, a pumping motion, etc. Further, the functional mechanical interface may be coupled with one or more airflow generating mechanisms of the musical instrument. Further, the one or more airflow generating mechanisms may be configured for generating airflow in the musical instrument based on the user action receivable by the functional mechanical interface.

In some embodiments, the instrument (i.e., the musical instrument) includes an instrument body (i.e., the body). Further, the mechanical interface (i.e., the mechanical interface element) may be coupled to the instrument body. Further, the mechanical interface may be coupled with one or more non functional airflow generating mechanisms comprised in the instrument body. Further, the one or more non functional airflow generating mechanisms may be non functional. Further, the one or more non functional airflow generating mechanisms replicate a form of the one or more airflow generating mechanisms of the musical instrument.

In some embodiments, the instrument body includes a frame. In some embodiments, the instrument body may be transparent. Further, in an embodiment, the instrument body may be comprised of one or more transparent materials. Further, the one or more transparent materials may include polycarbonates, plexiglass, transparent thermoplastic (Poly(methyl methacrylate)), etc.

In some embodiments, the instrument body may be comprised of one or more materials. Further, the one or more materials include one or more of a metallic material and a polymeric material. Further, the metallic material may include aluminum, aluminum alloy, etc. Further, the polymeric material may include polycarbonate.

In some embodiments, the one or more sensor information includes one or more operation values for one or more operation parameters. Further, the one or more operation parameters may include an angle of the mechanical interface in relation to the instrument body, a velocity of the mechanical interface, a displacement of the mechanical interface, a force applied on the mechanical interface, an orientation of the mechanical interface, a stroke length of stroking of the mechanical interface, a cycle duration of a movement of the mechanical interface, a duty cycle of a movement of the mechanical interface, a frequency of a movement of the mechanical interface, a number of movements of the mechanical interface, etc. Further, the one or more operation parameters characterize the operation. Further, the one or more musical instrument information includes one or more airflow generating mechanism information associated with the one or more airflow generating mechanisms. Further, the one or more airflow generating mechanism information includes one or more airflow mechanism parameters. Further, the one or more airflow mechanism parameters may include air pressure, rate of depletion of air pressure, rate of buildup of air pressure, reed activation threshold, a reed response time, air leakage, resonance (back pressure), etc. Further, the one or more airflow mechanism parameters may be in relation to one or more chambers (such as reed chambers, internal chambers, external chambers, etc.) of the musical instrument. Further, the one or more airflow mechanism parameters influence the one or more parameters. Further, the one or more airflow generating mechanism information further includes one or more instructions for determining one or more airflow generating mechanism values for the one or more airflow mechanism parameters based on the one or more operation values of the one or more operation parameters.

In some embodiments, the device further includes one or more user input devices communicatively coupled with the processing device. Further, the one or more user input devices may include a touchscreen, a keyboard, a user interface, etc. Further, in some embodiments, the one or more user input devices may be configured for generating one or more user customization information. Further, the processing device may be configured for analyzing the one or more user customization information. Further, the processing device may be configured for generating one or more user instructions for the determining of the one or more airflow generating mechanism values for the one or more airflow mechanism parameters based on the one or more operation values of the one or more operation parameters. Further, the one or more airflow generating mechanism information further includes the one or more user instructions.

In an embodiment, the device further includes one or more timing devices communicatively coupled with the processing device. Further, the one or more timing devices may include a clock device, a global positioning system (GPS) receiver, etc. Further, in some embodiments, the one or more timing devices may be configured for monitoring a time reference. Further, the time reference may include an absolute time reference, a relative time reference, etc. Further, the one or more airflow mechanism parameters may include one or more time dependent parameters and one or more time independent parameters. Further, the one or more time dependent parameters may be dependent on a time. Further, the one or more time independent parameters may be independent of the time. Further, the processing device may be configured for obtaining one or more time measurements based on the detecting of the observation and the monitoring of the time reference. Further, the one or more timing devices may be configured for monitoring a time reference. Further, the processing device may be configured for analyzing the one or more time measurements. Further, the one or more time measurements influence the one or more time dependent parameters of the one or more airflow mechanism parameters. Further, the determining of the one or more values for the one or more parameters may be further based on the analyzing of the one or more time measurements.

In some embodiments, the device further includes one or more input devices communicatively coupled with the processing device. Further, the one or more input devices may include switches, etc. Further, in some embodiments, the one or more input devices may be configured for generating one or more input information based on detecting a key action received on a key of one or more keys of the one or more instruments. Further, the one or more keys may be comprised in a keyboard. Further, the keyboard may be comprised in the instrument. Further, the keyboard structurally replicates a keyboard comprised in the musical instrument. Further, the one or more keys may be associated with one or more reeds of the musical instrument. Further, the processing device may be further configured for analyzing the one or more input information. Further, the processing device may be further configured for identifying the key based on the analyzing of the one or more input information. Further, the key may be associated with a reed of the one or more reeds. Further, the processing device may be further configured for identifying a reed information (reed data) associated with the reed based on the identifying of the key. Further, the reed information represents at least one acoustic model of a sound produced by the reed. Further, the processing device may be further configured for determining a playing action of the user based on the analyzing of the one or more input information. Further, the playing action corresponds to a playing of the one or more keys. Further, the processing device may be further configured for analyzing the reed information. Further, the determining of the one or more values of the one or more parameters may be further based on the analyzing of the reed information, and the determining of the playing action.

In some embodiments, the operation includes a movement of the mechanical interface with one or more movement characteristics. Further, the movement may include a displacement movement, an angular displacement movement, a rotatory movement, etc. Further, the one or more movement characteristics may include a velocity, a displacement, an orientation, an angular velocity, an angle, an acceleration, etc.

In some embodiments, the operation includes a change in one or more of a state, a position, and an orientation of the mechanical interface. In some embodiments, the feedback includes one or more haptic feedbacks. In some embodiments, the user action may be received from one or more hands of the user. Further, the one or more hands may be in contact with the mechanical interface. In some embodiments, the feedback may be provided to the one or more hands by the mechanical interface.

In some embodiments, the storage device may be further configured for retrieving one or more historical sensor information associated with a historical operation associated with the mechanical interface. Further, the processing device may be further configured for analyzing the one or more historical sensor information. Further, the determining of the one or more values of the one or more parameters may be further based on the analyzing of the one or more historical sensor information.

In some embodiments, the historical operation precedes the operation. In some embodiments, the determining of the feedback may be further based on the analyzing of the one or more historical sensor information. In some embodiments, the one or more sensors include a motion sensor. Further, the motion sensor may include an accelerometer,

In some embodiments, the one or more sensors include one or more of a position sensor, an orientation sensor, and a state sensor. Further, the one or more sensors, gyroscopes, magnetometers, inertial measurement unit sensors, tilt sensors, etc.

In some embodiments, the instrument includes an instrument body. Further, the operation includes a movement of the mechanical interface. Further, the feedback includes a resistance to the movement. Further, the one or more feedback output devices include one or more elastic elements and one or more elasticity control devices. Further, the mechanical interface may be connected to the instrument body using the one or more elastic elements. Further, an elasticity of the one or more elastic elements may be dynamically varied. Further, the one or more elasticity control devices may be configured for generating one or more control signals based on the determining of the feedback. Further, the one or more elastic elements may be configured for dynamically varying the elasticity of the one or more elastic elements to one or more elastic values based on the one or more control signals. Further, the providing of the feedback may be based on the dynamically varying of the elasticity.

In some embodiments, the one or more elastic elements may be comprised of one or more of a dielectric electroactive polymer, a magnetorheological elastomer, a thermally-responsive shape memory polymer, and an ionic polymer-metal composite.

In some embodiments, the one or more feedback output devices include one or more magnets, one or more electromagnets, and one or more magnet control devices. Further, the one or more electromagnets may be comprised in the instrument body, and the one or more magnets may be comprised in the mechanical interface. Further, the one or more electromagnets magnetically interface with the one or more magnets based on the movement of the mechanical interface. Further, the one or more magnet control devices may be configured for generating one or more control signals for the one or more electromagnets based on the determining of the feedback. Further, the one or more electromagnets may be configured for magnetizing with one or more magnetic strengths based on the one or more control signals for repelling the one or more magnets with a force of one or more magnitudes. Further, the providing of the feedback may be further based on the magnetizing of the one or more electromagnets with the one or more magnetic strengths.

In some embodiments, the one or more feedback output devices may include one or more first magnets, one or more second magnets, one or more actuators, and one or more magnet control devices. Further, the one or more first magnets may be comprised in the mechanical interface. Further, the one or more second magnets may be comprised in the body. Further, the one or more actuators may be coupled with the one or more second magnets. Further, the one or more magnet control devices may be operatively coupled with the one or more actuators. Further, the one or more magnet control devices may be configured for generating one or more control signals for the one or more actuators based on the determining of the feedback. Further, the one or more actuators transition the one or more second magnets to one or more of a position from a plurality of positions and an orientation from a plurality of orientations based on the one or more control signals. Further, the one or more second magnets in one or more of the position and orientations have a relative magnetic polarity with the one or more first magnets. Further, a magnetic force may be generated based on the relative magnetic polarity. Further, the magnetic force may be an attractive magnetic force, a repulsive magnetic force, etc. Further, the movement of the mechanical interface allows an interfacing of the one or more first magnets with the one or more second magnets. Further, the magnetic force may be further generated based on the interfacing of the one or more first magnets with the one or more second magnets. Further, the resistance to the movement may be provided based on the generating of the magnetic force generated based on the relative magnetic polarity between the one or more first magnets and the one or more second magnets, and the interfacing of the one or more first magnets with the one or more second magnets. Further, the one or more actuators may include an electric motor (such as a servo motor, a stepper motor, etc). Further, the electric motor may be electrically actuated by the one or more magnet control devices. Further, the one or more magnet control devices may include a controller, a processor, etc.

In some embodiments, the one or more feedback output devices include one or more conductive elements, one or more magnetic field sources, and one or more control devices. Further, the one or more conductive elements may be comprised in the mechanical interface, and the one or more magnetic field sources may be comprised in the instrument body. Further, the one or more conductive elements interface with the one or more magnetic field sources based on the movement of the mechanical interface. Further, the one or more control devices may be configured for generating one or more control signals based on the determining of the feedback. Further, the one or more magnetic field sources may be configured for generating a magnetic field of one or more intensities for inducing a resistive force of one or more magnitudes during the interfacing of the one or more conductive elements with the one or more magnetic field sources based on the one or more control signals and the movement of the mechanical interface. Further, the providing of the feedback may be further based on the generating of the magnetic field of the one or more intensities.

In some embodiments, the user action may be received from one or more hands of the user. Further, the user action includes one or more hand movements of the one or more hands. Further, the one or more feedback output devices include one or more wearable feedback devices. Further, the one or more wearable feedback devices may be configured to be worn on the one or more hands.

In some embodiments, the one or more wearable feedback devices include one or more elastic elements and one or more elasticity control devices. Further, the one or more wearable feedback devices may include wearable gloves. Further, an elasticity of the one or more elastic elements may be dynamically varied. Further, the one or more elasticity control devices may be configured for generating one or more control signals based on the determining of the feedback. Further, the one or more elastic elements may be configured for dynamically varying the elasticity of the one or more elastic elements to one or more elastic values based on the one or more control signals. Further, the providing of the feedback may be further based on the dynamically varying of the elasticity.

In some embodiments, the one or more wearable feedback devices include one or more muscle stimulation electrodes and one or more control devices. Further, the one or more control devices may be configured for generating one or more control signals based on the determining of the feedback. Further, the one or more muscle stimulation electrodes may be configured for applying a stimulation of one or more values to one or more muscles of the one or more hands based on the one or more control signals. Further, the providing of the feedback may be further based on the applying of the stimulation of the one or more values to the one or more muscles.

In an embodiment, the one or more control devices may include controllers, processors, processing units, etc. In an embodiment, the one or more control devices may include actuators. Further, the actuators may include motors. In some embodiments, the one or more output devices include one or more speakers.

Further, the device may include an instrument comprising an instrument body and a mechanical interface. Further, the mechanical interface may be coupled to the instrument body. Further, the instrument replicates a form of the musical instrument. Further, the mechanical interface replicates one or more of a form and a motion of a functional mechanical interface of a musical instrument. Further, the functional mechanical interface may be coupled with one or more airflow generating mechanisms of the musical instrument. Further, the device may include one or more sensors that may be configured for detecting an operation associated with the mechanical interface of the instrument. Further, the operation may be based on a user action of a user received by the mechanical interface. Further, the device may include a processing device communicatively coupled with the one or more sensors. Further, the processing device may be configured for obtaining one or more sensor information associated with the operation from the one or more sensors based on the detecting of the operation. Further, the processing device may be configured for analyzing the one or more sensor information and the one or more musical instrument information associated with the musical instrument. Further, the device simulates the experience of playing the musical instrument. Further, the processing device may be configured for determining one or more values of one or more parameters associated with a musical sound production based on the analyzing of the one or more sensor information and the one or more musical instrument information. Further, the processing device may be configured for synthesizing one or more musical sounds based on the one or more values of the one or more parameters. Further, the processing device may be configured for determining a feedback for the operation based on the analyzing of the one or more sensor information and the one or more musical instrument information. Further, the device may include a storage device communicatively coupled with the processing device. Further, the storage device may be configured for storing the one or more musical instrument information associated with the musical instrument. Further, the storage device may be configured for storing the one or more sensor information. Further, the device may include one or more output devices operatively coupled with the processing device. Further, the one or more output devices may be configured for producing the one or more musical sounds based on the synthesizing of the one or more musical sounds. Further, the device may include one or more feedback output devices operatively coupled with the processing device. Further, the one or more feedback output devices may be configured for providing the feedback to the user based on the determining of the feedback. Further, the user experiences the playing of the musical instrument based on the user action of the user, the feedback provided to the user, and the producing of the one or more musical sounds.

Further, the present disclosure describes an apparatus for producing musical sounds by simulating an experience of playing musical instruments includes the body, the mechanical interface element coupled to the body, the one or more sensors coupled to the body, the processing device coupled to the body and communicatively coupled with the one or more sensors, the storage device coupled to the body and communicatively coupled with the processing device, the one or more output devices coupled to the body and communicatively coupled with the processing device, and the one or more feedback output devices coupled to the body and communicatively coupled with the processing device. A user performs one or more user actions on the mechanical interface element, and the one or more sensors detect an operation associated with the mechanical interface element that is based on those user actions. The processing device generates one or more sensor information from the detected operation, analyzes the one or more sensor information, analyzes one or more musical instrument information associated with a selected musical instrument, and determines one or more values of one or more parameters associated with musical sound production based on the analyzed sensor information and the analyzed musical instrument information. The processing device then synthesizes one or more musical sounds from the determined parameter values and determines a feedback value for the operation based on the analyzed sensor information and the one or more musical instrument information. The storage device stores the one or more musical instrument information so that the processing device can access the instrument-specific response data during operation. The one or more output devices produce the one or more musical sounds based on the synthesizing of the musical sounds, and the one or more feedback output devices provide feedback to the user through the mechanical interface element based on the determined feedback.

In some embodiments, the body refers to a physical structural portion of the apparatus that supports, contains, mounts, positions, or spatially relates the remaining components of the apparatus. The body may be an enclosure, frame, chassis, shell, housing, support assembly, or instrument body structure formed from one or more rigid, semi-rigid, or composite materials. The body may define mounting locations for the mechanical interface element, sensors, keys, processing device, storage device, output devices, feedback output devices, user input devices, user output devices, and environmental sensing components. Because the body physically supports and positions the user-operable and control components of the apparatus, the body provides the structural platform through which user movement is detected, processed, and converted into sound and tactile output.

In some embodiments, the mechanical interface element refers to a physically movable or physically engageable structure through which a user applies one or more user actions to the apparatus in order to simulate the operation of a corresponding component of a musical instrument. The mechanical interface element may be a bellows flap, movable wall, hinged panel, pivoting member, sliding member, deformable member, lever, handle, pump-like member, or another mechanically actuatable part. The user may push, pull, compress, expand, pivot, deflect, rock, or otherwise move the mechanical interface element relative to the body. When the mechanical interface element is moved, one or more sensors detect the resulting operation, and the processing device uses the detected operation to determine one or more internal instrument-state values that govern sound synthesis and, in some embodiments, tactile feedback generation.

In some embodiments, the one or more sensors refer to one or more sensing devices configured to detect an operation associated with the mechanical interface element and to provide electrical sensor outputs corresponding to that operation. The one or more sensors may include accelerometers, gyroscopes, inertial measurement units, Hall-effect sensors, magnetic sensors, optical sensors, position sensors, displacement sensors, force sensors, pressure sensors, strain sensors, angle sensors, encoders, switches, or combinations thereof. The sensor outputs may be converted into one or more sensor information, which may denote one or more sensor-derived data values, one or more sensor-derived data sets, one or more processed signal values, or another representation of the detected operation. The one or more sensor information may represent position, displacement, angular displacement, direction, speed, acceleration, timing, force, repetition pattern, or another physical characteristic of movement or actuation of the mechanical interface element. In this way, the one or more sensors perform the function of converting physical user interaction with the instrument into machine-readable information that can be used by the processing device to control the operation of the apparatus. Further, the one or more user actions may be physical user interaction.

In some embodiments, the processing device refers to one or more electronic processing components that execute instructions, control logic, mathematical transformations, signal-processing operations, model evaluations, or combinations thereof to interpret user action and control sound generation and feedback. The processing device may include one or more microcontrollers, microprocessors, digital signal processors, embedded controllers, programmable logic devices, hardware accelerators, neural-processing modules, or combinations thereof. The processing device may receive sensor outputs and other inputs, generate and analyze one or more sensor information, access one or more musical instrument information stored in the storage device, determine one or more values of one or more parameters associated with musical sound production, synthesize one or more musical sounds, determine one or more feedback values, and control one or more output devices and one or more feedback output devices. Accordingly, the processing device performs the real-time control and signal-conversion functions that transform sensed user action into sound and, where applicable, tactile response.

In some embodiments, the storage device refers to one or more data-storage components that store information used by the processing device during operation of the apparatus. The storage device may include machine-readable storage medium suitable for storing executable instructions and data. The storage device may store one or more musical instrument information, one or more acoustic models, one or more mechanism models, one or more reed models, one or more airflow-response models, one or more feedback-control rules, one or more user settings, one or more calibration settings, one or more machine learning model parameters, or combinations thereof.

In some embodiments, the one or more musical instrument information refers to stored information associated with a musical instrument to be simulated by the apparatus. The one or more musical instrument information may include one or more instrument profiles, one or more acoustic models, one or more mechanism descriptions, one or more reed-response descriptions, one or more virtual-airflow relationships, one or more tonal-shaping rules, one or more calibration relationships, or other data representing behavior of the selected musical instrument. The one or more musical instrument information may be associated with a selected musical instrument, even if the overall apparatus is capable of simulating experiences corresponding to more than one musical instrument. The processing device may analyze the one or more musical instrument information to determine how sensed user movement should be converted into one or more sound-production parameters (i.e., one or more parameters) and, in some embodiments, one or more feedback parameters. The one or more musical instrument information, therefore, performs the role of providing instrument-specific response knowledge within the apparatus.

In some embodiments, the one or more values of one or more parameters associated with a musical sound production refer to one or more control values used by the processing device to govern the generation of musical sound. These parameters may include pitch-related values, tonal values, excitation values, resonance values, airflow-related values, damping values, gain values, temporal envelope values, reed-state values, model-state values, or other synthesis-control values. The processing device may compute these parameters from sensor information, key information, timing information, user customization information, environmental musical sound information, model outputs, or combinations thereof. Once determined, the parameter values are applied to one or more sound-generation procedures so that the output devices produce musical sound in accordance with the user's physical interaction and the stored instrument model.

In some embodiments, the one or more output devices refer to one or more components that convert sound-related electrical signals or audio values into audible output or another sound-output form perceivable by a listener. The one or more output devices may include speakers, headphone drivers, audio transducers, line-output circuitry, amplifiers, digital audio interfaces, or combinations thereof. The processing device may provide synthesized sound values to the one or more output devices, and the one or more output devices may then produce the one or more musical sounds based on those values. Thus, the one or more output devices perform the final sound-rendering function within the apparatus.

In some embodiments, the one or more feedback output devices refer to one or more components that convert one or more feedback values determined by the processing device into one or more physical outputs that are perceived by the user through the mechanical interface element or, in some embodiments, through the user's body. The one or more feedback output devices may include magnetic feedback mechanisms, electromechanical actuators, variable-stiffness mechanisms, conductive and magnetic induction mechanisms, stimulation control devices, and muscle stimulation electrodes, or other haptic-output structures. The processing device may determine a feedback value based on sensed movement and musical instrument information and may then command the one or more feedback output devices to generate a corresponding physical effect, such as a resistive force, counterforce, stiffness change, induced drag, or muscle stimulation. The one or more feedback output devices therefore perform the function of closing the tactile loop between the apparatus and the user.

In some embodiments, the feedback refers to a user-perceptible physical response generated by the apparatus in relation to the operation of the mechanical interface element. The feedback may be a resistance, counterforce, restoring force, variable stiffness effect, drag effect, vibration, stimulation, or another physical output correlated with a modeled state of the emulated musical instrument. The feedback is not merely an informational indicator; instead, it is a control output that changes how the user physically experiences and operates the apparatus. The processing device may determine feedback from the one or more sensor information, and the one or more musical instrument information, and the one or more feedback output devices may implement the determined feedback through one or more physical mechanisms.

In some embodiments, the one or more environment sensors may refer to one or more sensors configured to detect musical sounds or other acoustic activity in an environment of the apparatus. The one or more environment sensors may include microphones, acoustic pickup devices, or similar transducers mounted on or in the body of the apparatus. The one or more environment sensors may generate one or more environmental musical sound information representing sound currently present in the surrounding environment, and the processing device may use that information to modify the operation of the apparatus. The one or more environmental musical sound information may denote one or more data values, feature sets, or representations derived from the surrounding acoustic environment.

In some embodiments, the stimulation control devices refer to one or more circuits or control modules configured to control the application of stimulation through one or more muscle stimulation electrodes. The stimulation control devices may include pulse-generation circuitry, current-control circuitry, timing-control circuitry, safety-limiting circuitry, or other electronic structures that determine how stimulation is delivered. Further, the stimulation is provided through electrical signals of one or more signal characteristics corresponding to the stimulation settings, etc. The stimulation control devices may receive one or more feedback-control values from the processing device and convert those values into one or more stimulation settings, such as amplitude, intensity, pulse width, pulse frequency, or another stimulation parameter. The stimulation control devices, therefore, perform the function of translating a desired feedback state into a controlled stimulation output delivered through the muscle stimulation electrodes.

In some embodiments, synthesizing refers to electronically creating the musical sound from one or more calculated sound-production parameters, rather than outputting a previously stored recording of the sound. The processing device may use the determined parameter values, such as one or more pitch values, one or more virtual-airflow values, one or more excitation values, one or more resonance values, one or more tonal values, or one or more damping values, to generate one or more audio signal values that together define the waveform, tonal character, and dynamic behavior of the musical sound. In this manner, synthesizing performs the function of transforming the current modeled instrument state, which is based on the user's physical interaction with the apparatus and the stored musical instrument information, into an audible sound signal that can be rendered by the one or more output devices. Because the sound is generated from the current parameter values, the musical sound may change continuously and in real time as the user changes the movement of the mechanical interface element, key actuation, or other control inputs, thereby allowing the apparatus to emulate the responsive behavior of the corresponding musical instrument.

In some embodiments, the apparatus further includes one or more keys coupled to the body and one or more input devices coupled to the body and communicatively coupled with the processing device. Each key may be a physically depressible note-selection member configured to receive one or more key actions from the user, and the one or more keys may be associated with one or more reeds of the selected musical instrument through stored note-to-reed or key-to-reed relationships. The one or more input devices may detect a key action received on a key of the one or more keys and may generate one or more input information identifying the actuated key and, in some embodiments, the timing, displacement, or other actuation characteristic of the key. The processing device may analyze the one or more input information, identify the key based on that information, determine which reed is associated with the identified key, identify a reed information associated with the identified reed, and analyze the reed information. The reed information may represent an acoustic model of a sound produced by the identified reed, such as one or more reed-response parameters, excitation conditions, tonal features, or modeled reed-state values. The processing device may then determine the one or more sound-production parameter values using not only the sensor information from the mechanical interface element but also the analyzed reed information derived from the key actuation. Thus, the one or more keys perform the note-selection role, the one or more input devices perform the key-detection role, and the processing device performs the reed-identification and reed-model integration roles needed to relate key actions to modeled sound production.

In some embodiments, the processing device is further configured to determine one or more values of one or more operation parameters associated with the detected operation and to determine one or more values of one or more airflow mechanism parameters associated with one or more airflow generating mechanisms of the selected musical instrument. The processing device may derive the operation parameters from the one or more sensor information, and the operation parameters may represent displacement, angular displacement, movement direction, movement speed, acceleration, actuation repetition, motion history, or another physical characteristic of operation of the mechanical interface element. The processing device may then apply one or more stored relationships from the one or more musical instrument information to convert the operation parameters into one or more airflow mechanism parameters, such as virtual pressure, virtual flow rate, virtual bellows state, virtual pumping state, or another virtual-airflow quantity corresponding to an airflow-generating mechanism of the modeled musical instrument. Because the one or more airflow mechanism parameters are comprised in or defined by the one or more musical instrument information, the conversion from operation parameters to airflow mechanism parameters is instrument-specific rather than arbitrary. The processing device may then use the one or more airflow mechanism parameters as part of determining the one or more values of the one or more parameters associated with musical sound production. In this manner, the one or more sensors detect user-driven movement, the processing device computes operation parameters from the detected movement, and the processing device further computes virtual-airflow mechanism parameters that function as intermediate control states governing how sound is synthesized.

In some embodiments, the apparatus further comprises one or more user input devices disposed on the body and communicatively coupled with the processing device, the one or more user input devices being configured to generate one or more user customization information for customizing musical sound production. The one or more user input devices may include buttons, switches, sliders, dials, encoders, touch-sensitive controls, or other user-operable structures through which a player selects one or more instrument-response settings. The one or more user customization information may specify, for example, a desired mapping between movement and virtual-air pressure, a tonal preference, a reed-combination preference, a response sensitivity, or another customization that affects sound generation. The processing device may analyze the one or more user customization information and, using the analyzed customization information together with the analyzed musical instrument information, may determine one or more values of one or more airflow mechanism parameters associated with one or more airflow generating mechanisms of the selected musical instrument. The airflow mechanism parameters may therefore reflect both the stored instrument-specific response and the user-selected customization. Those airflow mechanism parameters may then be used by the processing device in determining the sound-production parameters applied to the synthesis path.

In some embodiments, the apparatus further comprises a timing device communicatively coupled with the processing device, the timing device being configured to monitor a time reference. The timing device may be a timer, oscillator-derived counter, internal clock resource, hardware clock, or other timekeeping structure capable of indicating elapsed time or event timing. The processing device may generate a time measurement from the monitored time reference and may use that time measurement, together with the analyzed musical instrument information, to determine one or more values of one or more airflow mechanism parameters associated with one or more airflow generating mechanisms of the selected musical instrument. The time measurement may indicate how long the mechanical interface element has been moving, the timing interval between repeated user actions, a duration for which a particular movement state is maintained, or another temporal characteristic relevant to a changing virtual-airflow condition. The processing device may combine the time measurement with the sensor-derived movement information and the stored instrument model so that the one or more airflow mechanism parameters evolve as a function of both movement and time. The processing device may then use those airflow mechanism parameters in determining the sound-production parameters for synthesis. In this way, the timing device performs the time-reference role, and the processing device performs the role of translating movement-plus-time behavior into a dynamic virtual-airflow model for sound generation.

In some embodiments, the operation associated with the mechanical interface element comprises a movement of the mechanical interface element in relation to the body, and the feedback provided to the user comprises a resistance opposing the movement of the mechanical interface element. The movement may be angular movement, translation, pivoting, flexure, compression, extension, or another mechanically perceptible displacement of the mechanical interface element relative to a portion of the body. The one or more sensors detect that movement and generate sensor outputs representing the movement, and the processing device determines a feedback value based on the detected movement and the one or more musical instrument information. The one or more feedback output devices then convert the determined feedback value into a resistance that acts against continued movement of the mechanical interface element. The resistance may be constant, variable, increasing, decreasing, nonlinear, or otherwise shaped according to the current modeled state of the selected musical instrument.

In some embodiments, the one or more feedback output devices comprise one or more first magnets, one or more second magnets, one or more actuators, and a magnet control device. The one or more first magnets are attached to one or more locations of the mechanical interface element so that movement of the mechanical interface element causes corresponding movement of the first magnets. The one or more actuators are coupled to the body and mechanically support the one or more second magnets so that the second magnets can be repositioned and/or reoriented relative to the first magnets. The magnet control device is operatively coupled with the one or more actuators and communicatively coupled with the processing device so that the magnet control device receives feedback-control information and generates one or more control signals for the actuators. In response to those control signals, the one or more actuators transition the one or more second magnets to one or more selected positions and/or orientations, thereby changing the relative magnetic polarity and the relative generated magnetic force between the one or more second magnets and the one or more first magnets during magnetic interfacing as the mechanical interface element moves. Because the first magnets move with the interface element and the second magnets are actively positioned or oriented by the actuators, the resulting magnetic interaction produces a controllable resistance opposing movement of the mechanical interface element.

In some embodiments, the one or more feedback output devices further comprise one or more additional sensors communicatively coupled with the processing device, the one or more additional sensors being configured to detect the one or more locations of the one or more first magnets and to detect one or more of a prior position and a prior orientation of the one or more second magnets. The one or more additional sensors may include Hall-effect sensors, magnetic position sensors, optical sensors, encoders, proximity sensors, or other sensor structures capable of identifying the actual geometric state of the magnetic feedback mechanism. When the mechanical interface element moves, the additional sensors generate sensor outputs indicating the current locations of the first magnets and the prior state of the second magnets. The magnet control device converts those sensor outputs into one or more location information for the first magnets and one or more prior position information and/or prior orientation information for the second magnets. The magnet control device then analyzes that information together with the desired feedback and determines one or more updated positions and/or orientations for the second magnets that are expected to produce the desired resistance. The magnet control device generates corresponding control signals for the actuators, and the actuators reposition and/or reorient the second magnets accordingly.

In some embodiments, the one or more first magnets are one or more permanent magnets, the one or more second magnets are one or more electromagnets, the magnet control device is operatively coupled with the one or more electromagnets, and the one or more feedback output devices further comprise an electromagnet driver operatively coupled with the magnet control device and the one or more electromagnets. The one or more permanent magnets move with the mechanical interface element and provide a fixed magnetic field reference associated with the moving interface. The one or more electromagnets provide a controllable magnetic field whose polarity and magnitude depend on the current supplied to them. The magnet control device may determine a required current direction and a required current magnitude for energizing the one or more electromagnets based on the desired feedback and may generate one or more control signals causing the electromagnet driver to supply current having the required current direction and the required current magnitude to the one or more electromagnets. The required current direction determines the effective polarity of the electromagnets, and the required current magnitude determines the strength of their magnetic field. As a result, the relative magnetic polarity and the relative generated magnetic force between the one or more electromagnets and the one or more permanent magnets are actively controlled during movement of the mechanical interface element, thereby producing a controlled resistance opposing movement.

In some embodiments, the one or more feedback output devices comprise one or more elastic elements and one or more elasticity control devices, the mechanical interface element being connected to the body using the one or more elastic elements, and an elasticity of the one or more elastic elements being dynamically variable. The one or more elastic elements may be springs, compliant members, flexures, elastomeric members, variable-stiffness members, or other mechanical structures that oppose movement of the mechanical interface element relative to the body. The one or more elasticity control devices may include preload adjusters, variable clamping mechanisms, motor-driven tensioning devices, variable-stiffness mechanisms, or other control structures that change the effective elasticity experienced by the user. The processing device may determine a desired feedback value and provide corresponding control information to the one or more elasticity control devices, and the one or more elasticity control devices may generate one or more control signals that adjust the one or more elastic elements to an elasticity value selected from a plurality of elasticity values. When the user moves the mechanical interface element, the adjusted one or more elastic elements then produce a corresponding resistance force that depends on the selected elasticity value.

In some embodiments, the one or more feedback output devices comprise one or more conductive elements, one or more magnetic field sources, and one or more control devices. The one or more conductive elements may be metallic plates, conductive bars, conductive loops, conductive traces, or other electrically conductive structures coupled to the mechanical interface element so that they move with the mechanical interface element relative to the body. The one or more magnetic field sources may be electromagnets, permanent-magnet assemblies with adjustable geometry, or other magnetic-field-generating structures coupled to the body and arranged such that movement of the conductive elements causes the conductive elements to move through or relative to a magnetic field. The one or more control devices may control the magnetic field sources by adjusting field intensity, current level, activation state, or another field-related control parameter based on the desired feedback determined by the processing device. As the conductive elements move relative to the magnetic field, an induced electromagnetic interaction generates a resistive force opposing movement of the mechanical interface element, and the magnitude of that resistive force depends on the field condition and the motion condition.

In some embodiments, the user applies the one or more user actions by performing the one or more user actions on the mechanical interface element using one or more hands of the user, and the resistance opposing the movement applies one or more counteractions, such as one or more counterforces, on the one or more hands during performance of the user actions. The one or more hands may grasp, push, pull, press, or otherwise physically engage the mechanical interface element, and the resistance produced by the one or more feedback output devices is transmitted through the mechanical interface element into the user's hand or hands. Because the resistance is physically delivered through the same interface element used to control sound generation, the user experiences an opposing force that changes the effort and feel of playing. The one or more sensors and the processing device may coordinate the timing and magnitude of the counterforce with the current movement of the mechanical interface element and the current modeled instrument state so that the counteraction corresponds to the selected virtual-airflow or other instrument condition.

In some embodiments, the one or more feedback output devices comprise one or more muscle stimulation electrodes and one or more stimulation control devices, the one or more stimulation control devices being configured to generate one or more control signals based on the determined feedback. The one or more muscle stimulation electrodes may be arranged for placement on, near, or in contact with one or more muscles of the one or more hands so that the apparatus can apply a controlled stimulation while the user performs the one or more user actions on the mechanical interface element. The one or more stimulation control devices may include pulse-generation circuitry, timing-control circuitry, current-control circuitry, or other electronics that receive feedback-control values from the processing device and convert those values into one or more stimulation settings, such as amplitude, pulse width, pulse frequency, duty cycle, or another stimulation value. The one or more stimulation control devices may then drive the one or more muscle stimulation electrodes according to the selected stimulation value so that one or more muscles of the one or more hands experience a stimulation corresponding to the current feedback state. The resulting stimulation supplements or represents the feedback provided to the user and is physically perceived during instrument operation.

In some embodiments, the one or more musical instrument information comprises a respective acoustic model for each of a plurality of instrument mechanisms of the selected musical instrument, the plurality of instrument mechanisms comprising one or more airflow generating mechanisms, one or more sound generating mechanisms, and one or more sound modifying mechanisms. Each respective acoustic model may include one or more mechanism parameters associated with the corresponding instrument mechanism, such as virtual pressure values, virtual airflow values, excitation values, reed-state values, resonance values, damping values, tonal-shaping values, or coupling values. The processing device may analyze the one or more sensor information and the one or more musical instrument information and determine one or more values of the one or more mechanism parameters for one or more of the plurality of instrument mechanisms. The processing device may then determine the one or more values of the one or more parameters associated with the musical sound production from the determined mechanism-parameter values. For example, movement of the mechanical interface element may update an airflow-generating mechanism parameter, the updated airflow parameter may influence a sound-generating mechanism parameter associated with a modeled reed, and the resulting sound state may be further shaped by one or more sound-modifying mechanism parameters.

In some embodiments, the apparatus further comprises one or more environment sensors communicatively coupled with the processing device, the one or more environment sensors being configured to detect one or more environmental musical sounds playing in an environment of the apparatus. The one or more environment sensors may include microphones or equivalent acoustic transducers mounted on or in the body of the apparatus. The one or more environment sensors generate signals corresponding to surrounding music or surrounding instrument sound, and the processing device converts those signals into one or more environmental musical sound information. The processing device may analyze the one or more environmental musical sound information to determine one or more environmental characteristics relevant to the operation of the apparatus, such as surrounding loudness, tonal balance, spectral content, accompaniment density, or presence of other instruments. The processing device may then generate one or more customization information for customizing the musical sound production based on the analyzed environmental musical sound information and the analyzed musical instrument information, and may use that customization information to determine one or more values of one or more mechanism parameters for the plurality of instrument mechanisms.

In some embodiments, the processing device is further configured for generating one or more recommendations for customizing the musical sound production based on the analysis of the one or more environmental musical sound information and the analysis of the one or more musical instrument information. The apparatus further comprises a user output device communicatively coupled with the processing device and a user input device communicatively coupled with the processing device. The user output device may be a display, indicator, audio prompt interface, or other presentation device through which the processing device presents the one or more recommendations to the user. The user input device may be a button, selector, switch, encoder, touch interface, or other input mechanism through which the user provides an input indicating acceptance, rejection, or modification of a recommendation. The processing device may analyze the input received from the user input device and may generate or refine one or more customization information based on the analyzed input. The refined customization information may then be applied in determining one or more sound-production or mechanism-control values for operation of the apparatus.

In some embodiments, the analyzing of the one or more musical instrument information comprises analyzing the one or more musical instrument information using one or more first machine learning models, and the analyzing of the one or more sensor information comprises analyzing the one or more sensor information using one or more second machine learning models connected with the one or more first machine learning models, the one or more second machine learning models being configured to generate one or more second outputs based on one or more first outputs generated by the one or more first machine learning models. The one or more first machine learning models may receive stored instrument-related inputs, such as acoustic-model parameters, airflow-response information, reed-model information, tonal-shaping data, mechanism descriptions, or calibration data, and may generate one or more first outputs in the form of instrument-specific latent embeddings, feature vectors, prior-state values, conditioning values, or model-selection values summarizing properties of the selected musical instrument. The one or more second machine learning models may receive the one or more first outputs together with real-time one or more sensor information from the mechanical interface element and, in some embodiments, key input information, timing information, prior state information, or feedback-state information. The one or more second machine learning models may then generate one or more second outputs representing predicted sound-production parameters, predicted virtual-airflow values, predicted mechanism parameters, predicted feedback-control values, or other current control outputs used by the processing device. The connection between the first and second machine learning models may be implemented by passing the first outputs as feature vectors, latent embeddings, conditioning signals, hidden-state initialization values, gating values, attention-conditioning values, or equivalent machine-learning inputs to the second models. The processing device may execute the first machine learning models to obtain instrument-conditioned first outputs, execute the second machine learning models to combine those first outputs with current sensor-derived information, and determine the one or more values of the one or more parameters associated with musical sound production based on the one or more second outputs.

In some embodiments, the mechanical interface element replicates one or more of a form and a motion of a functional mechanical interface element of the selected musical instrument, and the mechanical interface element is non-functional in the sense that it does not itself perform the airflow-generating function performed by the corresponding acoustic mechanical interface element of the original instrument. The replicated form may include a corresponding size, shape, travel path, mounting location, hinge arrangement, surface geometry, or user-contact geometry. The replicated motion may include pushing, pulling, pumping, pivoting, opening, closing, or another movement corresponding to the original instrument component. When the user moves the replicated mechanical interface element, the one or more sensors detect that movement and provide corresponding sensor outputs to the processing device. The processing device then converts the detected movement into one or more virtual-airflow-related or other modeled instrument-state values and uses those values to determine sound-production parameters and, in some embodiments, feedback parameters. Thus, although the mechanical interface element does not itself create actual airflow for sound production, it performs the ergonomic and kinematic simulation role that allows the apparatus to emulate the playing experience of the selected musical instrument while replacing actual airflow generation with sensed movement and electronic modeling.

In some embodiments, the musical instrument represented by the stored musical instrument information is a harmonium, and the mechanical interface element comprises an airless bellows flap disposed on a side of the body and mounted for user-driven angular movement relative to the body about a hinge, flexure region, fold line, sliding guide, or other mechanical support. The one or more sensors comprise an accelerometer mounted on an outer side of the bellows flap such that, when the user pushes or pulls the bellows flap, the accelerometer generates electrical output values corresponding to angular displacement, angular direction, angular velocity, and optionally angular acceleration of the bellows flap. The processing device receives the accelerometer output values, filters and time-aligns those values, derives a movement state of the bellows flap from the accelerometer output values, and converts the movement state into a virtual-air parameter that represents a modeled airflow-related condition of the harmonium, such as virtual bellows pressure, virtual airflow rate, or virtual air reservoir state. The processing device then applies the virtual-air parameter in determining one or more sound-production parameters used by the synthesis engine and, in some embodiments, one or more feedback parameters used by the feedback output device, such that movement of the bellows flap performs the same control role that physical bellows airflow performs in an acoustic harmonium, even though the apparatus remains airless. In this way, the bellows flap is not merely an ornamental replica, and the accelerometer is not merely an informational sensor; rather, the bellows flap, accelerometer, and processing device cooperate to convert physical bellows-like actuation into real-time instrument-state control that governs both sound generation and, optionally, tactile feedback.

In some embodiments, the processing device is configured to synthesize the one or more musical sounds from acoustic modeling of reeds without playback of sampled pre-recorded sound, such that the processing device generates audio output values by executing one or more reed-behavior models rather than by retrieving a stored note recording. The acoustic modeling of reeds may include computation of one or more model states corresponding to reed excitation, reed vibration onset, oscillation behavior, coupling to a virtual-airflow state, resonance behavior, damping behavior, and spectral output behavior. The processing device may receive current values of key information, sensor information, and virtual-airflow parameters, apply those values to the reed model to update one or more reed-state variables, compute one or more instantaneous or frame-based audio values from the updated reed-state variables, and provide those audio values to the one or more output devices for rendering as audible sound. Because the sound is synthesized from updated model states rather than from pre-recorded waveforms, the generated sound changes continuously in response to changes in user movement, key actuation, and virtual airflow, thereby allowing the apparatus to produce musical sounds in a manner that tracks the physical interaction of the user with the instrument.

In some embodiments, the user customization information includes a reed-combination selection associated with the accompaniment of a vocalist, and the processing device modifies the sound-production parameters according to the selected reed combination by changing one or more model parameters used by the synthesis engine. The reed-combination selection may correspond to a selected set of modeled reeds, a selected weighting between modeled reed groups, a selected harmonic profile, or a selected tonal balance suited for vocal accompaniment. The one or more user input devices may receive the reed-combination selection as a button press, switch position, menu selection, or encoder setting, and may provide corresponding customization information to the processing device. In response, the processing device identifies the selected reed-combination setting, retrieves associated parameter values or combination rules from the storage device, and updates one or more sound-production parameters, such as gain values, harmonic-weighting values, resonance values, or excitation distribution values, that control how the synthesis engine generates sound for subsequent key actions and bellows-related movement.

In some embodiments, the processing device determines a virtual-air pressure value according to a user-defined mapping between repeated movement of the mechanical interface element and generated virtual-air pressure, the user-defined mapping being stored as one or more conversion relationships in the storage device and applied by the processing device during operation of the instrument. The repeated movement may be characterized by one or more measured movement features, such as count of pumping strokes, stroke amplitude, angular excursion, direction reversals, movement frequency, average velocity, or a combination thereof, derived from sensor information generated while the user repeatedly actuates the mechanical interface element. The user-defined mapping may be implemented as a lookup table, interpolation table, piecewise function, response curve, polynomial relationship, threshold map, or other stored calibration relationship that specifies how the measured movement features correspond to one or more virtual-air pressure values. The processing device may detect the repeated movement, compute the relevant movement features, apply the user-defined mapping to those features, and thereby determine a virtual-air pressure value used in the sound-generation control path. The virtual-air pressure value may then be applied to control modeled reed excitation, tonal output, and optionally haptic resistance, so that the physical manner in which the user repeatedly moves the mechanical interface element to control virtual-air generation through a specifically defined and user-calibrated transformation.

In some embodiments, the processing device automatically adjusts at least one audio characteristic of the synthesized musical sounds based on environmental musical sounds detected in an environment of the apparatus so as to balance the synthesized musical sounds with one or more other instruments, the one or more environment sensors comprising microphones or equivalent acoustic transducers mounted on the apparatus. During operation, the one or more environment sensors capture ambient musical sound and generate corresponding electrical signals, the processing device converts those electrical signals into environmental musical sound information, and the processing device analyzes that information to determine one or more environmental performance conditions, such as surrounding loudness, dominant spectral content, competing tonal regions, rhythmic density, or accompaniment intensity. The processing device then computes one or more adjustment values for one or more audio characteristics of the apparatus, such as output level, tonal contour, harmonic emphasis, resonance weighting, modeled reed weighting, or equalization state, and applies those adjustment values to the sound-production parameters used by the synthesis engine. As a result, the apparatus performs the automatic adjustment by sensing the surrounding musical environment, algorithmically determining a balancing adjustment, and then changing the operation of the sound-generation engine so that the generated sound remains better integrated with the external instruments or music in the environment.

In some embodiments, the body comprises polycarbonate and supports a keyboard structurally replicating a keyboard of the musical instrument, such that the body not only houses the processing, sensing, and output components, but also mechanically supports a user-playable keyboard whose geometry corresponds to that of the emulated instrument. The polycarbonate body may be formed from molded, machined, or assembled polycarbonate structural parts that provide dimensional stability, reduced weight, and resistance to environmental wear while positioning the keyboard, bellows-like mechanical interface element, sensors, output devices, and feedback devices in fixed spatial relationships to one another. The keyboard structurally replicating the keyboard of the musical instrument may include replicated key spacing, key arrangement, key travel, key height, key width, or other keyboard geometry such that a user's finger movements on the keyboard correspond to a familiar performance technique of the acoustic instrument. As the user depresses a key, the one or more input devices detect the key action, provide corresponding input information to the processing device, and the processing device associates that action with a corresponding modeled reed or note state.

In some embodiments, the processing device comprises a microcontroller configured to generate the one or more musical sounds with low latency after detection of key presses, the microcontroller being an embedded control device that executes one or more real-time instruction sequences stored in memory to process sensor inputs and produce audio output values. The one or more input devices detect a key press and generate key-related information, the microcontroller receives that information together with sensor information from the mechanical interface element, determines current instrument-state values including one or more sound-production parameters, computes one or more audio samples or audio control values, and sends corresponding output values to the one or more output devices without perceptible or performance-impairing delay. The low-latency operation is achieved by the microcontroller performing these steps in a time-constrained control loop using onboard timing resources, interrupt-based event handling, efficient state updates, and direct control of sound-generation and output circuitry.

In some embodiments, the resistance opposing movement of the mechanical interface element corresponds to a simulated bellows-pressure state determined from sensed movement of the mechanical interface element in the absence of actual airflow through the apparatus, such that the same virtual state governs both audible behavior and tactile behavior of the apparatus. The one or more sensors generate movement-related sensor information as the user actuates the mechanical interface element, the processing device converts that sensor information into a simulated bellows-pressure state representing a modeled internal pressure condition, and the processing device applies the simulated bellows-pressure state both to one or more sound-production parameters used by the synthesis engine and to one or more feedback-control parameters used by the one or more feedback output devices. The feedback output devices then generate a resistance force opposing further movement of the mechanical interface element, the resistance force being scaled, shaped, or otherwise controlled according to the simulated bellows-pressure state. Accordingly, the simulated bellows-pressure state performs a dual function within the apparatus: it determines how the synthesized sound behaves, and it determines how the haptic resistance behaves, thereby ensuring that the feel of the instrument and the sound of the instrument arise from the same modeled virtual-airflow condition.

In some embodiments, the one or more sensors comprise an accelerometer mounted on a movable bellows portion of the mechanical interface element, and the processing device converts detected angular displacement and angular velocity of the movable bellows portion into a virtual-airflow state that controls sound synthesis in real time. The movable bellows portion may be mounted so that user actuation causes repeatable angular movement relative to the body, and the accelerometer, being fixed directly to that movable portion, generates output values that correspond to the actual physical kinematics of the bellows-like movement. The processing device receives the accelerometer output values, determines angular displacement and angular velocity from those output values, and applies a stored movement-to-airflow transformation to compute a virtual-airflow state. The virtual-airflow state is then used immediately, in the same or a subsequent real-time control cycle, to update one or more sound-production parameters that govern synthesized sound output.

In some embodiments, the one or more musical sounds are produced by acoustic modeling of reed behavior without playback of sampled audio, and the processing device updates at least one sound-production parameter continuously during movement of the mechanical interface element so that the audible output remains dynamically coupled to the user's physical action. During performance, the one or more sensors generate updated movement-related information, and, where present, the one or more input devices generate updated key-related information, and the processing device uses those updated values to continuously recalculate one or more sound-production parameters, such as virtual airflow excitation, reed excitation magnitude, resonance weighting, damping coefficient, pitch-related state, or harmonic emphasis. The processing device then applies the recalculated sound-production parameter values to the reed-behavior model to produce updated audio output values. Because the parameter update occurs continuously during movement of the mechanical interface element rather than only at note onset, the generated sound changes throughout the user's ongoing manipulation of the instrument.

In some embodiments, the processing device comprises a microcontroller configured to execute a real-time control loop that receives sensor inputs, updates one or more mechanism parameters, and outputs synthesized sound with latency suitable for live performance. In each control cycle, the microcontroller may sample or receive sensor inputs from the one or more sensors, receive key input data from one or more input devices, update one or more operation parameters and one or more mechanism parameters of the modeled instrument, compute one or more sound-production parameters, synthesize corresponding audio output values, and transmit the output values to the one or more output devices. The microcontroller may repeat the control cycle at a rate selected to preserve a close temporal relationship between user action and sound response, thereby causing user movement and key actuation to be rendered as audible output without performance-disruptive delay.

In some embodiments, the feedback output provided through the mechanical interface element emulates bellows air pressure without actual airflow by controlling magnetic interaction between a movable element and a body-coupled element. The movable element may be fixed to or move with the mechanical interface element, and the body-coupled element may be fixed to the body or positioned relative to the body by an actuator or other control structure. The processing device determines a desired feedback level from the current virtual-airflow state or other instrument-state value, and a control device adjusts magnetic polarity, magnetic position, magnetic orientation, magnetic field strength, or another magnetic-interaction parameter of the movable element and the body-coupled element to produce a force opposing movement of the mechanical interface element. As the user moves the mechanical interface element, the resulting magnetic force is physically transmitted through that interface element to the user's hand and is perceived as bellows-like air pressure.

In some embodiments, the processing device modifies one or more sound-production parameters in response to environmental musical sounds detected near the apparatus so that the synthesized musical sounds remain balanced with other instruments in a performance environment. One or more environment sensors detect the environmental musical sounds and generate electrical signals corresponding to the surrounding audio. The processing device converts those signals into environmental musical sound information, and the processing device analyzes that information to determine one or more conditions of the surrounding performance environment, such as current loudness balance, spectral crowding, or competing accompaniment content. The processing device then computes one or more modified sound-production parameters and applies those modified parameters to the synthesis engine so that the generated musical output better occupies an available tonal or dynamic space in the surrounding ensemble.

In some embodiments, the user customization information includes a selectable mapping between user movement of the mechanical interface element and a generated virtual-air pressure value used to determine the one or more parameters associated with musical sound production. The selectable mapping may be defined by stored calibration coefficients, a lookup table, a response curve, a nonlinear function, or another relationship associating one or more measured movement characteristics with one or more virtual-air pressure values. The user selects the mapping using one or more user input devices, the processing device receives corresponding customization information, and the processing device thereafter applies the selected mapping whenever movement-related sensor information is received from the mechanical interface element. By applying the selected mapping to the sensor information, the processing device generates a virtual air pressure value that then influences one or more sound-production parameters used by the synthesis engine.

In some embodiments, analyzing the one or more musical instrument information comprises analyzing the one or more musical instrument information using one or more first machine learning models, and analyzing the one or more sensor information comprises analyzing the one or more sensor information using one or more second machine learning models that are connected with the one or more first machine learning models, the one or more second machine learning models being configured to generate one or more second outputs based on one or more first outputs generated by the one or more first machine learning models. The one or more first machine learning models may be instrument-knowledge models that receive stored musical instrument information as input and generate structured first outputs representing instrument-specific latent features, such as reed-response embeddings, airflow-response embeddings, instrument-mechanism-state priors, parameter-influence weights, tonal-response signatures, or model-selection indicators associated with the particular instrument being emulated. The one or more second machine learning models may be performance-state models that receive as input the first outputs from the first machine learning models together with real-time sensor information from the mechanical interface element and, in some embodiments, key input information, timing information, or feedback-state information. The one or more second machine learning models may then generate second outputs representing predicted sound-production parameters, predicted airflow mechanism parameters, predicted reed-state parameters, predicted haptic-feedback parameters, predicted latent instrument states, or updated control values for the synthesis engine. The connection between the first and second machine learning models may be implemented by passing the first outputs as feature vectors, conditioning vectors, latent-state vectors, initial hidden states, prior distributions, attention keys, attention values, gating signals, or parameter-selection signals to the second machine learning models. In some embodiments, the first machine learning models comprise one or more embedding networks, encoder networks, graph-based mechanism models, parameter-regression networks, or instrument-classification networks trained to capture relationships among stored acoustic-model features of the instrument, and the second machine learning models comprise one or more temporal sequence models, recurrent neural networks, gated recurrent units, long short-term memory networks, temporal convolutional networks, transformer-based time-series models, state-space sequence models, or hybrid learned-state estimators trained to map time-varying user interaction data to time-varying sound-production control outputs. During operation, the processing device executes the first machine learning models to obtain the first outputs from the stored musical instrument information, executes the second machine learning models to combine the first outputs with current sensor information, and then determines the one or more values of the one or more parameters associated with musical sound production based on the resulting second outputs.

In some embodiments, the one or more first machine learning models comprise one or more teacher models trained using a training dataset representing the acoustic behavior of the musical instrument, and the one or more second machine learning models comprise one or more student models trained by distillation from outputs of the one or more teacher models and deployed by the processing device during live performance. The teacher models may be implemented as larger-capacity neural networks, multi-branch encoder networks, transformer models, graph neural networks, or hybrid model-based and data-driven networks that receive stored musical instrument information together with labeled or simulated performance data and learn instrument-specific relationships among movement, virtual airflow, reed behavior, and produced sound. During training, the teacher models may generate soft targets, latent embeddings, probability distributions, intermediate feature tensors, or predicted control-parameter trajectories that reflect fine-grained instrument behavior learned from the training data. The student models may be smaller recurrent networks, temporal convolutional networks, compact transformers, or other embedded-suitable networks that are trained to reproduce the relevant teacher outputs while reducing computational cost, memory usage, and inference latency. During live performance, the processing device executes the student models on real-time sensor information and conditioning information so that the apparatus obtains teacher-informed predictions with computational efficiency suitable for a microcontroller or other embedded processor.

In some embodiments, the one or more teacher models are trained to generate instrument-specific latent embeddings representing relationships among airflow mechanism parameters, reed-model parameters, and sound-modifying parameters, and the one or more student models are trained to predict one or more sound-production parameters from sensor information conditioned on the instrument-specific latent embeddings. The teacher models may receive stored musical instrument information defining airflow mechanisms, reed characteristics, resonance characteristics, tonal-shaping characteristics, mechanism couplings, and calibration relationships, and may transform that information into one or more dense or structured latent embeddings that encode how the particular instrument responds internally to user actuation. The student models may receive, as input, both real-time sensor information from the mechanical interface element and the latent embeddings generated by the teacher models, such that the student-model inference is instrument-conditioned rather than generic. The student models may then compute sound-production parameters, virtual-airflow parameters, reed-excitation parameters, or feedback-control parameters based on both the current user movement and the instrument-specific latent representation.

In some embodiments, the one or more second machine learning models comprise a temporal sequence model configured to receive a time-ordered window of sensor information generated during movement of the mechanical interface element and to output a time-varying estimate of a virtual-airflow state used in determining the one or more parameters associated with musical sound production. The time-ordered window may include a plurality of successive sensor samples representing position, angular displacement, angular velocity, acceleration, stroke count, direction changes, timing intervals, or combinations thereof collected over a recent period of instrument operation. The temporal sequence model may be implemented as a recurrent neural network, long short-term memory network, gated recurrent unit network, temporal convolutional network, transformer-based sequence model, or state-space sequence model, each configured to exploit temporal dependencies across multiple sensor samples rather than relying on a single instantaneous reading. The processing device feeds the time-ordered sensor window into the temporal sequence model, receives a predicted time-varying virtual-airflow estimate, and uses that estimate to determine sound-production parameters for the synthesis engine and, in some embodiments, feedback parameters for the haptic mechanism. Accordingly, the temporal sequence model performs inference of an evolving internal instrument state from a time history of physical movement, thereby allowing the apparatus to reproduce dynamic bellows-like behavior more faithfully than a memoryless mapping.

In some embodiments, the one or more second machine learning models are trained using a loss function that includes a teacher-student consistency term and a physics-based constraint term that penalizes outputs inconsistent with stored musical instrument information. The teacher-student consistency term may compare one or more student outputs, intermediate features, logits, or latent states with corresponding teacher outputs or representations so that the student models learn to approximate the teacher-model behavior. The physics-based constraint term may evaluate whether predicted virtual-airflow values, reed-state values, sound-production parameters, or feedback values satisfy one or more instrument-specific relationships derived from the stored musical instrument information, such as monotonic pressure-flow relationships, bounded parameter ranges, allowed state transitions, energy-related consistency conditions, or timing-response limits. During training, an optimization routine adjusts trainable weights of the student model so as to minimize both the consistency term and the physics-based constraint term, thereby producing a student model whose outputs remain both teacher-informed and instrument-consistent. As a result, when the student model is deployed in the apparatus, the predicted control outputs are less likely to drift into implausible or nonphysical states and are more strongly tied to the actual operation of the modeled musical instrument.

In some embodiments, the one or more first machine learning models include an instrument-embedding model stored in the storage device and executable by the processing device. The instrument-embedding model receives one or more musical instrument information associated with a selected musical instrument and generates an instrument-conditioned feature vector. In some embodiments, the one or more musical instrument information includes one or more reed-model parameters, one or more virtual-airflow response parameters, one or more resonance parameters, one or more leakage parameters, one or more tonal-shaping parameters, and one or more calibration parameters. The instrument-conditioned feature vector may include a fixed-length latent representation of the selected musical instrument for use during live performance.

In some embodiments, the one or more second machine learning models include a temporal sequence model configured to receive a time-ordered window of sensor information generated by the one or more sensors during movement of the mechanical interface element. In some embodiments, the time-ordered window includes a plurality of consecutive samples of acceleration, angular velocity, angular displacement, direction of movement, stroke count, elapsed time between direction reversals, and one or more key-action values. By way of example and not limitation, the time-ordered window may include sixty-four consecutive sensor frames sampled over a recent movement interval of the mechanical interface element. The temporal sequence model may include a gated recurrent unit network, a long short-term memory network, a temporal convolutional network, or a transformer-based time-series model.

In some embodiments, the processing device is configured to preprocess the sensor information before inference by filtering the sensor information, normalizing the sensor information using one or more stored calibration values, and arranging the normalized sensor information into the time-ordered window. The processing device may be further configured to provide the time-ordered window and the instrument-conditioned feature vector to the temporal sequence model and to receive one or more second outputs from the temporal sequence model. In some embodiments, the one or more second outputs include a virtual-air pressure value, a virtual-airflow rate value, a reed-excitation value, a sound-production parameter value, a feedback-control value, and a confidence value associated with one or more of the foregoing outputs.

In some embodiments, the processing device is configured to select, from among a plurality of stored student models, a selected student model corresponding to a selected musical instrument type, reed configuration, or user customization mode, and to generate the one or more second outputs using the selected student model during operation of the apparatus. The storage device may store multiple student models trained for different instrument families, different harmonium reed arrangements, different bellows-response settings, different tonal styles, or different customization regimes. The processing device may receive a selection input from a user input device, may identify a current instrument mode from stored configuration data, or may infer a current operating mode from the stored musical instrument information, and may then load, activate, or route inference through the student model associated with that mode. Once selected, the student model receives real-time sensor information and any conditioning information and generates the second outputs that determine current sound-production or feedback-control parameters.

In some embodiments, the one or more second machine learning models are configured to output both a predicted sound-production parameter value and a confidence value associated with the predicted sound-production parameter value, and the processing device is configured to determine the one or more values of the one or more parameters based on the predicted sound-production parameter value when the confidence value satisfies a threshold condition. The confidence value may be a probability, certainty score, variance-related metric, uncertainty score, entropy-based score, or other reliability indicator derived from the student-model inference. During operation, the student model processes current sensor information and any model-conditioning inputs to generate a candidate control output together with the corresponding confidence value. The processing device compares the confidence value against a stored threshold condition and, when the threshold is satisfied, applies the candidate control output directly to the synthesis engine and, in some embodiments, to the feedback control path. When the threshold is not satisfied, the processing device may hold a prior parameter value, blend the student-model output with a deterministic model output, invoke a fallback physics-based estimator, or reduce the rate of parameter change. Thus, the confidence value performs a gating function that controls whether and how the learned model output is permitted to influence the live operation of the instrument.

In some embodiments, the processing device is configured to update one or more personalization parameters of the one or more second machine learning models based on calibration movements performed by a user on the mechanical interface element, while maintaining one or more core model parameters fixed during live performance. The calibration movements may include one or more prescribed bellows-like strokes, slow and fast movement sequences, wide and narrow displacement sequences, repeated pumping patterns, or other guided actuation patterns captured from the particular user. The one or more sensors detect those calibration movements, and the processing device computes user-specific movement descriptors such as range, speed profile, repetition rate, asymmetry, preferred force pattern, or timing characteristics. The processing device then updates personalization parameters such as scaling coefficients, adapter weights, bias terms, user embeddings, or low-rank adaptation parameters while keeping deeper core network weights or other foundational model parameters fixed. During subsequent live performance, the second machine learning model uses the fixed core parameters together with the updated personalization parameters to generate sound-production outputs that better match the user's physical playing style.

In some embodiments, the one or more first machine learning models comprise a mechanism-relation model configured to model interactions among a plurality of instrument mechanisms, and the one or more second machine learning models comprise a control-output model configured to transform outputs of the mechanism-relation model and the sensor information into sound-production parameters and feedback parameters. The mechanism-relation model may receive stored musical instrument information describing airflow-generating mechanisms, sound-generating mechanisms, and sound-modifying mechanisms and may produce outputs representing mechanism-coupling strengths, latent mechanism states, dependency matrices, relational embeddings, or predicted mechanism interaction coefficients. The control-output model may receive those relational outputs together with real-time sensor information and, in some embodiments, key information and timing information, and may compute sound-production parameters for the synthesis engine and feedback parameters for the haptic subsystem. Accordingly, the mechanism-relation model performs the role of learning and expressing internal instrument-structure relationships, while the control-output model performs the role of translating current user movement and learned mechanism relationships into actionable control values for the apparatus.

In some embodiments, the processing device includes one or more machine learning execution modules configured to cooperate with one or more stored musical instrument models and one or more real-time sensing modules so as to determine sound-production parameters, virtual-airflow parameters, and, in some embodiments, feedback-control parameters for operation of the apparatus. The machine learning execution modules may be executed on a microcontroller, digital signal processor, application processor, neural-processing accelerator, field-programmable gate array, or another embedded computational resource carried by the body of the apparatus. The machine learning execution modules are not used as an end in themselves, but instead operate inside the instrument control path, receiving stored instrument information and real-time user-action information and producing control outputs that govern the synthesis of musical sound and optionally the generation of haptic feedback.

In some embodiments, a first set of machine learning models receives stored musical instrument information and generates instrument-conditioned outputs that summarize properties of the instrument to be emulated. The stored musical instrument information supplied to the first set of machine learning models may include acoustic-model parameters, reed-characterization parameters, airflow-response parameters, tonal-shaping parameters, resonance characteristics, mechanism-coupling information, user-selected instrument modes, and calibration data. The first set of machine learning models may be implemented as one or more encoders, embedding networks, graph neural networks, parameter-regression models, transformer encoders, or other feature-extraction networks configured to output one or more latent embeddings, feature vectors, prior-state values, mechanism-coupling values, or conditioning signals representing instrument-specific behavior. These outputs may then be supplied to a second set of machine learning models that process real-time sensor information so that the live inference path remains conditioned on the specific instrument architecture and instrument state being simulated.

In some embodiments, the second set of machine learning models receives real-time sensor information from the one or more sensors coupled to the mechanical interface element and optionally receives key input information, timing information, prior state information, and feedback-state information. The second set of machine learning models may be implemented as recurrent neural networks, long short-term memory networks, gated recurrent unit networks, temporal convolutional networks, transformer-based sequence models, state-space sequence models, or hybrid networks that combine learned sequence modeling with deterministic signal processing. The second set of machine learning models may output predicted sound-production parameters, predicted virtual-airflow states, predicted reed-excitation values, predicted mechanism parameters, predicted feedback-control values, or confidence values associated with those outputs. The processing device may then apply the predicted outputs directly or indirectly to the synthesis engine and feedback subsystem so that current physical movement of the instrument causes corresponding current changes in sound generation and tactile behavior.

In some embodiments, the machine learning models are trained using a teacher-student framework in which one or more teacher models are trained offline using a larger-capacity architecture and one or more student models are trained to reproduce selected outputs, intermediate representations, or latent states of the teacher models. The training data for the teacher models may include recorded sensor traces, simulated movement traces, labeled virtual-airflow trajectories, labeled reed-state trajectories, audio-derived target parameters, modeled instrument states, or combinations thereof representing expected behavior of the instrument under different playing conditions. The teacher models may therefore learn high-capacity relationships among physical movement, instrument-conditioned variables, and desired control outputs. The student models may then be trained using one or more distillation losses that encourage the student models to match selected teacher outputs while using reduced computational complexity suitable for live deployment on embedded hardware carried by the apparatus. During live operation, the processing device may execute the student models rather than the teacher models so as to obtain inference latency and memory usage compatible with live musical performance.

In some embodiments, the teacher-student training process includes the generation of soft targets by the teacher models. The soft targets may include latent embeddings, probability distributions across candidate control states, smoothed parameter trajectories, predicted intermediate mechanism states, or attention-weighted feature representations. The student models may be trained to reproduce those soft targets in addition to, or instead of, reproducing only hard labeled outputs. Because the soft targets preserve relational information and uncertainty patterns captured by the teacher models, the student models can learn a richer control behavior than would be obtained from hard labels alone.

In some embodiments, the machine learning training process includes one or more physics-based or instrument-consistency constraints. The physics-based or instrument-consistency constraints may be defined using stored musical instrument information and may penalize model outputs that violate known instrument relationships, such as impossible parameter ranges, invalid state transitions, inconsistent airflow-to-reed excitation relationships, invalid coupling between modeled mechanisms, abrupt discontinuities inconsistent with expected physical response, or timing-response behavior inconsistent with the instrument model. Such constraints may be incorporated into the training loss as regularization terms, penalty terms, constrained optimization terms, or projection-based correction steps.

In some embodiments, sequence-based inference is used to estimate the virtual-airflow state from the recent history of movement of the mechanical interface element. The processing device may gather a sliding window of sensor samples representing displacement, angular displacement, angular velocity, acceleration, stroke count, actuation timing, direction changes, or other movement descriptors and supply that window to a temporal sequence model. The temporal sequence model may process the ordered sensor history and output a current estimate of virtual pressure, virtual flow rate, virtual reservoir state, or another airflow-related state variable. The processing device may then use that estimated state variable as part of the determination of sound-production parameters for the synthesis engine and, in some embodiments, haptic feedback parameters for the feedback output devices.

In some embodiments, the processing device may use confidence-aware inference. More particularly, a machine learning model may output both a predicted control value and a confidence value associated with that predicted control value. The confidence value may be compared with one or more stored threshold conditions, and the processing device may determine whether to accept the predicted control value, reject it, blend it with a deterministic model output, smooth it over time, or hold a prior control value based on the confidence value. In this way, the model can contribute learned control behavior without causing unstable or unreliable operation of the instrument when the model is uncertain or operating outside a familiar movement regime. The confidence-aware control path, therefore, provides a technical safeguard for live musical use.

In some embodiments, personalization is supported through user-specific calibration and adaptation. During a calibration procedure, the apparatus may instruct the user to perform one or more reference movements of the mechanical interface element, such as slow strokes, fast strokes, short strokes, long strokes, repeated strokes, or force-emulation patterns. The one or more sensors detect those calibration movements, and the processing device computes one or more personalization values from the detected motion, such as scaling values, offsets, style embeddings, adaptation vectors, or lightweight adapter weights. Those personalization values may then be applied to the deployed student model while deeper or core model weights remain fixed.

In some embodiments, multiple trained student models may be stored in the storage device, each corresponding to a different musical instrument type, reed configuration, tonal mode, virtual-airflow response profile, or user customization mode. The processing device may select one of the stored student models based on a user selection, a loaded instrument profile, or a detected operating context, and may thereafter use the selected student model to generate real-time control outputs. This model-selection architecture allows one apparatus to support multiple simulated instrument behaviors while retaining low-latency inference for each behavior. The selected model may therefore function as part of a configurable but concrete control system for the physical musical instrument.

In some embodiments, the machine learning outputs are used in conjunction with deterministic instrument modeling rather than as a complete replacement for deterministic computation. For example, a machine learning model may estimate a virtual-airflow state or a reed-excitation parameter, while a deterministic acoustic model uses that estimated value together with stored physical-response parameters to synthesize musical sound. In some embodiments, the machine learning model may provide a correction term, compensation term, predicted latent state, or parameter-initialization value to a deterministic solver or rule-based estimator.

In some embodiments, the processing device may employ a fallback mode when a machine learning inference output is unavailable, unreliable, or inconsistent with stored instrument constraints. In the fallback mode, the processing device may compute sound-production parameters using a deterministic mapping from sensor information to virtual-airflow parameters and from virtual-airflow parameters to sound-generation parameters. The fallback mode may be invoked when a confidence value is below a threshold, when sensor data is incomplete, when an anomaly is detected, or when a selected performance mode favors a deterministic response.

In some embodiments, the machine learning models may be trained using a dataset assembled from one or more of measured actuation data from a physical instrument, measured response data from a prototype apparatus, simulated actuation-response pairs derived from an acoustic model, manually labeled calibration sequences, or performance data recorded from one or more users. The dataset may include synchronized sensor traces, key traces, virtual-airflow targets, parameter targets, audio targets, environmental-sound context, user-customization context, and feedback targets. By training on synchronized multi-source data, the machine learning models may learn correlations among physical movement, stored instrument properties, resulting sound behavior, and desired feedback behavior in a manner that is directly relevant to the operation of the apparatus.

In some embodiments, the outputs of the machine learning models may include not only sound-production parameters but also parameters for the one or more feedback output devices. For example, the model may output a predicted resistance value, a predicted magnetic-force target, a predicted elasticity target, or another haptic-control value derived from real-time movement and instrument-conditioned state. The processing device may use that output to control the magnetic, elastic, or other haptic mechanism so that the tactile response remains coordinated with the synthesized sound response.

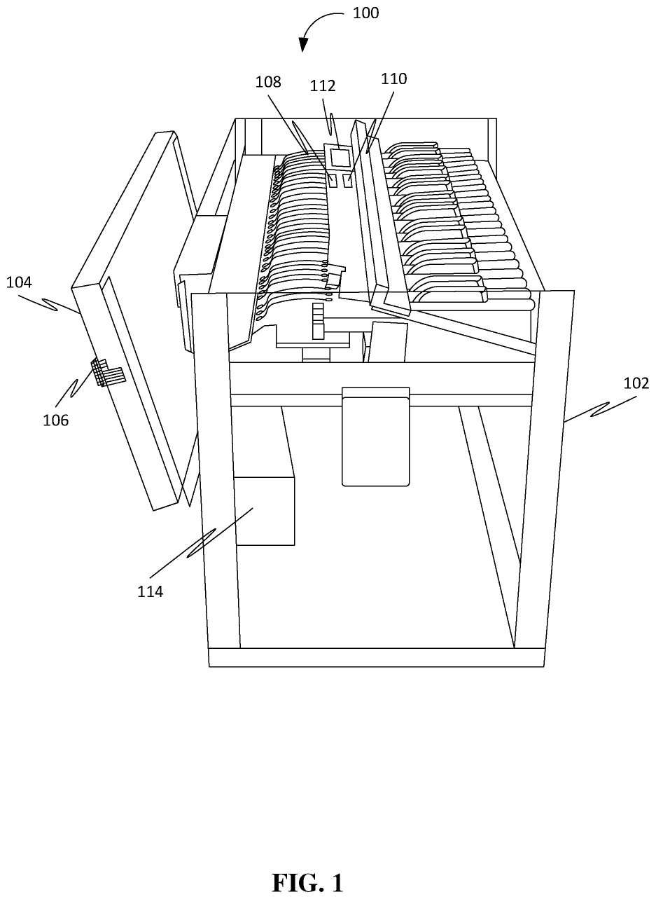

FIG. 1 is a left side top perspective view of an apparatus 100 for producing musical sounds by simulating an experience of playing musical instruments, in accordance with some embodiments. Accordingly, the apparatus 100 may include a body 102, a mechanical interface element 104, one or more sensors 106, a processing device 108, a storage device 110, one or more output devices 112, and one or more feedback output devices 114.

Further, the mechanical interface element 104 may be coupled to the body 102. Further, the mechanical interface element 104 may be configured to receive one or more user actions from a user. Further, the one or more sensors 106 may be coupled to the body 102. Further, the one or more sensors 106 may be configured for detecting an operation associated with the mechanical interface element 104. Further, the operation may be based on the one or more user actions received by the mechanical interface element 104. Further, the processing device 108 may be coupled to the body 102. Further, the processing device 108 may be communicatively coupled with the one or more sensors 106. Further, the processing device 108 may be configured for generating one or more sensor information based on the detecting of the operation. Further, the processing device 108 may be configured for analyzing the one or more sensor information. Further, the processing device 108 may be configured for analyzing one or more musical instrument information associated with a musical instrument. Further, the processing device 108 may be configured for determining one or more values of one or more parameters associated with a musical sound production based on the analyzing of the one or more sensor information and the analyzing of the one or more musical instrument information. Further, the processing device 108 may be configured for synthesizing one or more musical sounds based on the one or more values of the one or more parameters. Further, the processing device 108 may be configured for determining a feedback for the operation based on the analyzing of the one or more sensor information and the one or more musical instrument information. Further, the storage device 110 may be coupled to the body 102. Further, the storage device 110 may be communicatively coupled with the processing device 108. Further, the storage device 110 may be configured for storing the one or more musical instrument information associated with the musical instrument. Further, the one or more output devices 112 may be coupled to the body 102. Further, the one or more output devices 112 may be communicatively coupled with the processing device 108. Further, the one or more output devices 112 may be configured for producing the one or more musical sounds based on the synthesizing of the one or more musical sounds. Further, the one or more feedback output devices 114 may be coupled to the body 102. Further, the one or more feedback output devices 114 may be communicatively coupled with the processing device 108. Further, the one or more feedback output devices 114 may be configured for providing feedback to the user through the mechanical interface element 104 based on the determining of the feedback.

In some embodiments, the apparatus 100 may include one or more keys 202-206 and one or more input devices 208. Further, the one or more keys 202-206 may be coupled to the body 102. Further, the one or more keys 202-206 may be configured to receive one or more key actions. Further, the one or more keys 202-206 may be associated with one or more reeds of the musical instrument. Further, the one or more input devices 208 may be coupled to the body 102. Further, the one or more input devices 208 may be communicatively coupled with the processing device 108. Further, the one or more input devices 208 may be configured for generating one or more input information based on detecting a key action received on a key of the one or more keys 202-206. Further, the processing device 108 may be configured for analyzing the one or more input information. Further, the processing device 108 may be configured for identifying the key based on the analyzing of the one or more input information. Further, the key may be associated with a reed of the one or more reeds. Further, the processing device 108 may be configured for identifying a reed information associated with the reed based on the identifying of the key. Further, the reed information represents an acoustic model of a sound produced by the reed. Further, the processing device 108 may be configured for analyzing the reed information. Further, the determining of the one or more values of the one or more parameters may be further based on the analyzing of the reed information.

Further, in some embodiments, the processing device 108 may be further configured for determining one or more values of one or more operation parameters associated with the operation based on the analyzing of the one or more sensor information. Further, the processing device 108 may be configured for determining one or more values of one or more airflow mechanism parameters associated with one or more airflow generating mechanisms of the musical instrument based on the one or more values of the one or more operation parameters, and the analyzing of the one or more musical instrument information. Further, the one or more airflow mechanism parameters may be comprised in the one or more musical instrument information. Further, the determining of the one or more values of the one or more parameters may be further based on the one or more values of the one or more airflow mechanism parameters.

In further embodiments, the apparatus 100 may include one or more user input devices 302 disposed on the body 102. Further, the one or more user input devices 302 may be communicatively coupled with the processing device 108. Further, the one or more user input devices 302 may be configured for generating one or more user customization information for customizing the musical sound production. Further, the processing device 108 may be further configured for analyzing the one or more user customization information. Further, the processing device 108 may be configured for determining one or more values of one or more airflow mechanism parameters associated with one or more airflow generating mechanisms of the musical instrument based on the analyzing of the one or more user customization information and the analyzing of the one or more musical instrument information. Further, the one or more airflow mechanism parameters may be comprised in the one or more musical instrument information. Further, the determining of the one or more values of the one or more parameters may be further based on the one or more values of the one or more airflow mechanism parameters.

In further embodiments, the apparatus 100 may include a timing device 410 communicatively coupled with the processing device 108. Further, the timing device 410 may be configured for monitoring a time reference. Further, the processing device 108 may be configured for generating a time measurement based on the monitoring of the time reference. Further, the processing device 108 may be configured for determining one or more values of one or more airflow mechanism parameters associated with one or more airflow generating mechanisms of the musical instrument based on the time measurement and the analyzing of the one or more musical instrument information. Further, the one or more airflow mechanism parameters may be comprised in the one or more musical instrument information. Further, the determining of the one or more values of the one or more parameters may be further based on the one or more values of the one or more airflow mechanism parameters.

Further, in some embodiments, the operation associated with the mechanical interface element 104 may include a movement of the mechanical interface element 104 in relation to the body 102. Further, the feedback provided to the user may include a resistance opposing the movement of the mechanical interface element 104.

Further, in an embodiment, the one or more feedback output devices 114 comprise one or more first magnets 402, one or more second magnets 404, one or more actuators 406, and a magnet control device 408. Further, the one or more first magnets 402 may be attached to one or more locations of the mechanical interface element 104. Further, the one or more actuators 406 may be coupled to the body 102. Further, the one or more second magnets 404 may be mechanically coupled to the one or more actuators 406. Further, the magnet control device 408 may be operatively coupled with the one or more actuators 406. Further, the magnet control device 408 may be communicatively coupled with the processing device 108. Further, the magnet control device 408 may be configured for generating one or more control signals for the one or more actuators 406 based on the determining of the feedback. Further, the one or more actuators 406 may be configured for transitioning the one or more second magnets 404 to one or more of a position from a plurality of positions and an orientation from a plurality of orientations based on the one or more control signals. Further, the one or more second magnets 404 magnetically interface with the one or more first magnets 402 based on the movement of the mechanical interface element 104. Further, one or more of the position and the orientation define a relative magnetic polarity and a relative generated magnetic force between the one or more second magnets 404 and the one or more first magnets 402 during the magnetic interfacing. Further, the resistance to the movement may be produced based on the relative magnetic polarity and the relative generated magnetic force.

Further, in an embodiment, the one or more feedback output devices 114 may include one or more additional sensors 502 communicatively coupled with the processing device 108. Further, the one or more additional sensors 502 may be further configured for detecting the one or more locations of the one or more first magnets 402. Further, the one or more additional sensors 502 may be further configured for detecting one or more of a prior position and a prior orientation of the one or more second magnets 404. Further, the magnet control device 408 may be configured for generating one or more location information of the one or more locations of the one or more first magnets 402 based on the detecting of the one or more locations of the one or more first magnets 402. Further, the magnet control device 408 may be configured for generating one or more of a prior position information of the prior position, and a prior orientation information of the prior orientation of the one or more second magnets 404 based on the detecting of one or more of the prior position and the prior orientation of the one or more second magnets 404. Further, the magnet control device 408 may be configured for analyzing the one or more location information and one or more of the prior position information and the prior orientation information based on the feedback. Further, the magnet control device 408 may be configured for determining one or more of the position and the orientation based on the analyzing of the one or more location information and one or more of the prior position information and the prior orientation information. Further, the generating of the one or more control signals may be further based on the determining of one or more of the position and the orientation.

Further, in an embodiment, the one or more first magnets 402 may be one or more permanent magnets. Further, the one or more second magnets 404 may be one or more electromagnets. Further, the magnet control device 408 may be operatively coupled with the one or more electromagnets. Further, the magnet control device 408 may be further configured for determining a required current direction and a required current magnitude for energizing the one or more electromagnets based on the feedback. Further, the generating of the one or more control signals may be further based on the determining of the required current direction and the required current magnitude for energizing the one or more electromagnets. Further, the one or more feedback output devices 114 further may include an electromagnet driver 504 operatively coupled with the magnet control device 408 and the one or more electromagnets. Further, the electromagnet driver 504 may be configured for energizing the one or more electromagnets with the current having the required current direction and the required current magnitude based on the one or more control signals. Further, the one or more electromagnets further magnetically interface with the one or more permanent magnets based on the energizing of the one or more electromagnets. Further, the current having the required current direction and the required current magnitude further defines the relative magnetic polarity and the relative generated magnetic force between the one or more electromagnets and the one or more permanent magnets during the magnetic interfacing.

Further, in an embodiment, the one or more feedback output devices 114 comprise one or more elastic elements 602 and one or more elasticity control devices 604. Further, the mechanical interface element 104 may be connected to the body 102 using the one or more elastic elements 602. Further, an elasticity of the one or more elastic elements 602 may be dynamically variable. Further, the one or more elasticity control devices 604 may be configured for generating one or more control signals based on the determining of the feedback. Further, the one or more elastic elements 602 may be configured for dynamically varying the elasticity of the one or more elastic elements 602 to an elasticity value of a plurality of values based on the one or more control signals. Further, the providing of the feedback may be based on the dynamically varying of the elasticity.

Further, in an embodiment, the one or more feedback output devices 114 comprise one or more conductive elements 702, one or more magnetic field sources 704, and one or more control devices 706. Further, the one or more conductive elements 702 may be coupled to the mechanical interface element 104, and the one or more magnetic field sources 704 may be coupled to the body 102. Further, the one or more control devices 706 may be configured for generating one or more control signals based on the determining of the feedback. Further, the one or more magnetic field sources 704 may be configured for generating a magnetic field of one or more intensities for inducing a resistive force of one or more magnitudes to oppose the movement during an interaction of the one or more conductive elements 702 with the magnetic field based on the one or more control signals and the movement of the mechanical interface element 104. Further, the providing of the feedback may be further based on the generating of the magnetic field of the one or more intensities.

Further, in an embodiment, the user applies the one or more user actions by performing the one or more user actions on the mechanical interface element 104 using one or more hands of the user. Further, the resistance opposing the movement applies one or more counteractions on the one or more hands of the user during the performing of the one or more user actions.

Further, in an embodiment, the one or more feedback output devices 114 include one or more muscle stimulation electrodes 802 and one or more stimulation control devices 804. Further, the one or more stimulation control devices 804 may be configured for generating one or more control signals based on the determining of the feedback. Further, the one or more muscle stimulation electrodes 802 may be configured for applying a stimulation of a value of a plurality of values to one or more muscles of the one or more hands based on the one or more control signals. Further, the providing of the feedback may be further based on the applying of the stimulation of the value to the one or more muscles.

Further, in some embodiments, the one or more musical instrument information may include a respective acoustic model for each of a plurality of instrument mechanisms of the musical instrument. Further, the plurality of instrument mechanisms may include one or more airflow generating mechanisms, one or more sound generating mechanisms, and one or more sound modifying mechanisms. Further, each respective acoustic model may include one or more mechanism parameters associated with a respective instrument mechanism. Further, the processing device 108 may be further configured for determining one or more values of the one or more mechanism parameters for one or more of the plurality of instrument mechanisms based on the analyzing of the one or more sensor information and the analyzing of the one or more musical instrument information. Further, the determining of the one or more values of the one or more parameters associated with the musical sound production may be further based on the one or more values of the one or more mechanism parameters.

In an embodiment, the apparatus 100 may include one or more environment sensors 902 communicatively coupled with the processing device 108. Further, the one or more environment sensors 902 may be configured for detecting one or more environmental musical sounds playing in an environment of the apparatus 100. Further, the processing device 108 may be configured for generating one or more environmental musical sound information based on the detecting of the one or more environmental musical sounds. Further, the processing device 108 may be configured for analyzing the one or more environmental musical sound information. Further, the processing device 108 may be configured for generating one or more customization information for customizing the musical sound production based on the analyzing of the one or more environmental musical sound information, and the analyzing of the one or more musical instrument information. Further, the determining of the one or more values of the one or more mechanism parameters for one or more of the plurality of instrument mechanisms may be based on the one or more customization information.

Further, in an embodiment, the processing device 108 may be further configured for generating one or more recommendations for customizing the musical sound production based on the analyzing of the one or more environmental musical sound information and the analyzing of the one or more musical instrument information. Further, the apparatus 100 further may include a user output device 1002 communicatively coupled with the processing device 108. Further, the user output device 1002 may be configured for presenting the one or more recommendations. Further, the apparatus 100 further may include a user input device 1004 communicatively coupled with the processing device 108. Further, the user input device 1004 may be configured for receiving an input from the user. Further, the processing device 108 may be further configured for analyzing the input. Further, the generating of the one or more customization information may be further based on the analyzing of the input.

Further, in some embodiments, the analyzing of the one or more musical instrument information may include analyzing the one or more musical instrument information using one or more first machine learning models. Further, the one or more first machine learning models may be configured for generating one or more first outputs. Further, the analyzing of the one or more sensor information may include analyzing the one or more sensor information using one or more second machine learning models. Further, the one or more second machine learning models may be connected with the one or more first machine learning models. Further, the one or more second machine learning models may be configured for generating one or more second outputs based on the one or more first outputs. Further, the determining of the one or more values of the one or more parameters associated with the musical sound production may be further based on the one or more second outputs.

Further, in some embodiments, the mechanical interface element 104 replicates one or more of a form and a motion of a functional mechanical interface element 104 of the musical instrument. Further, the mechanical interface element 104 may be non-functional.

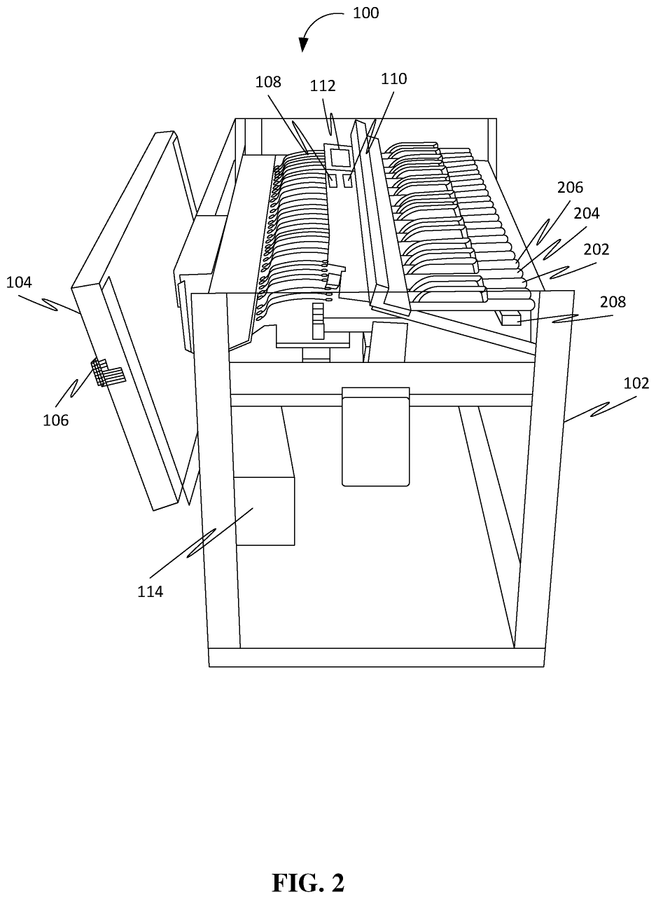

FIG. 2 is a left side top perspective view of the apparatus 100 with the one or more input devices 208, in accordance with some embodiments. Further, the apparatus 100 may include the one or more input devices 208.

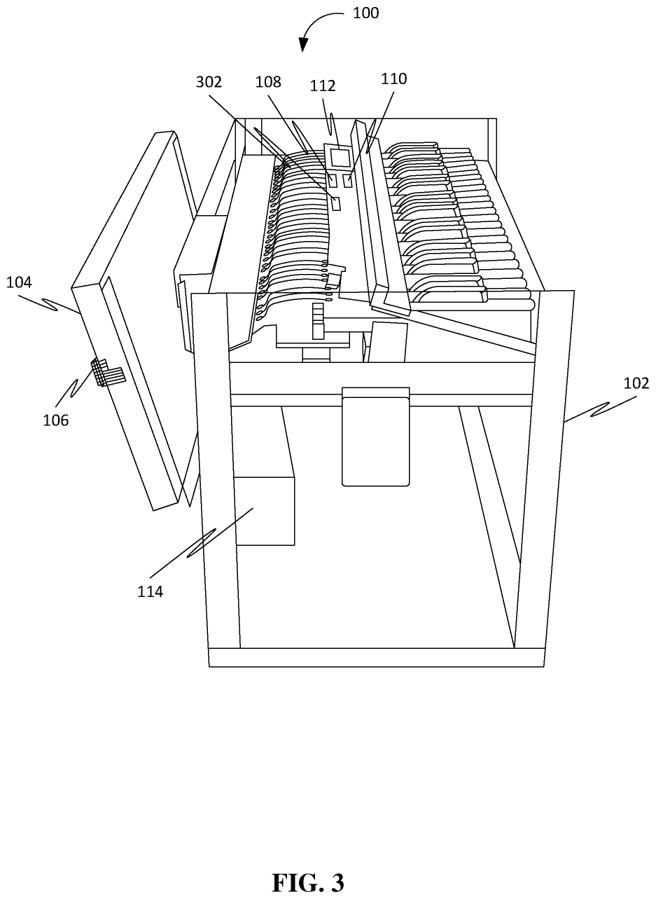

FIG. 3 is a left side top perspective view of the apparatus 100 with the one or more user input devices 302, in accordance with some embodiments. Further, the apparatus 100 may include the one or more user input devices 302.

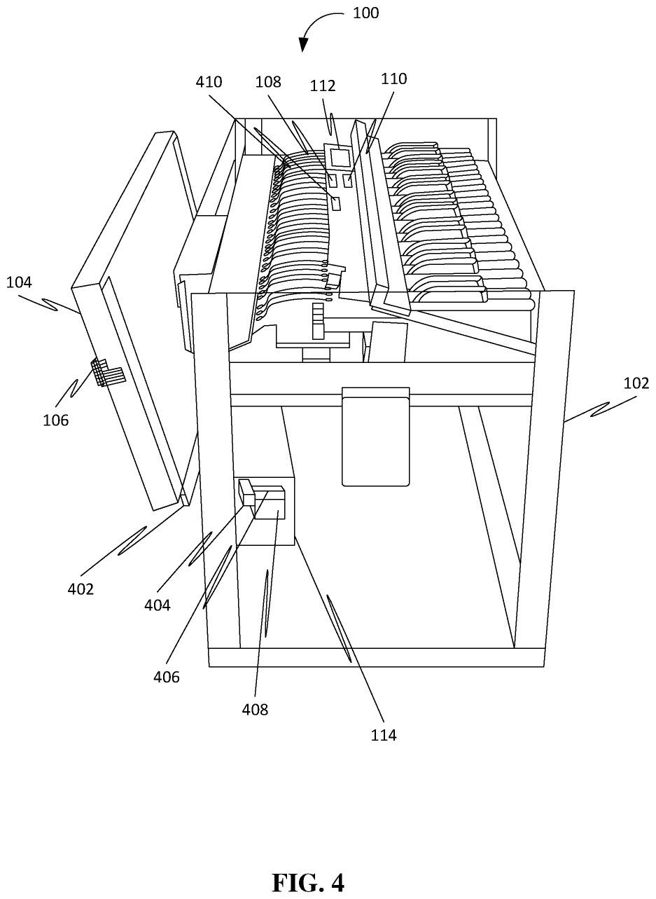

FIG. 4 is a left side top perspective view of the apparatus 100 with the timing device 410, in accordance with some embodiments. Further, the apparatus 100 may include the timing device 410.

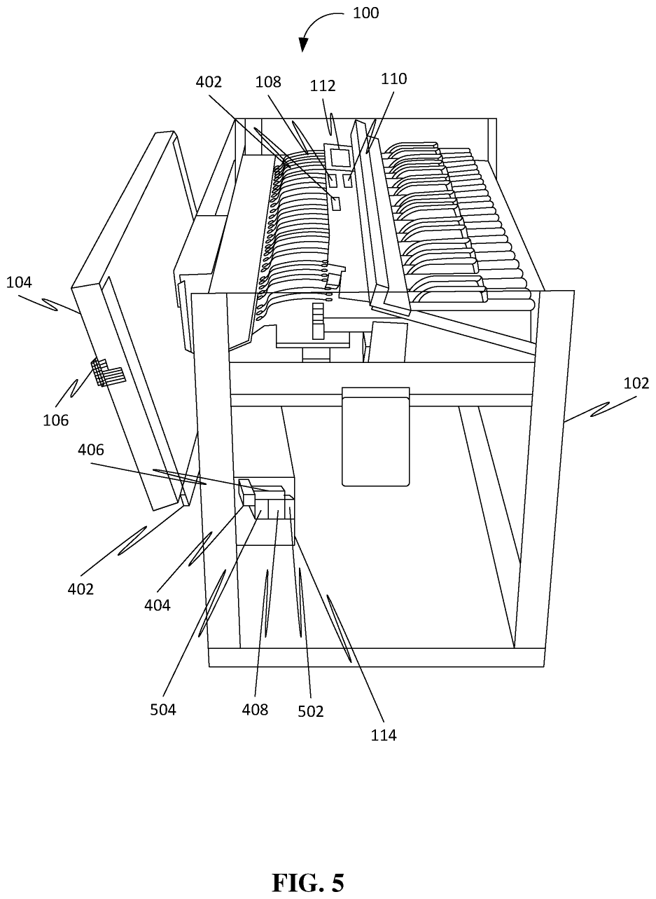

FIG. 5 is a left side top perspective view of the apparatus 100 with the one or more additional sensors 502, in accordance with some embodiments. Further, the apparatus 100 may include the one or more additional sensors 502.

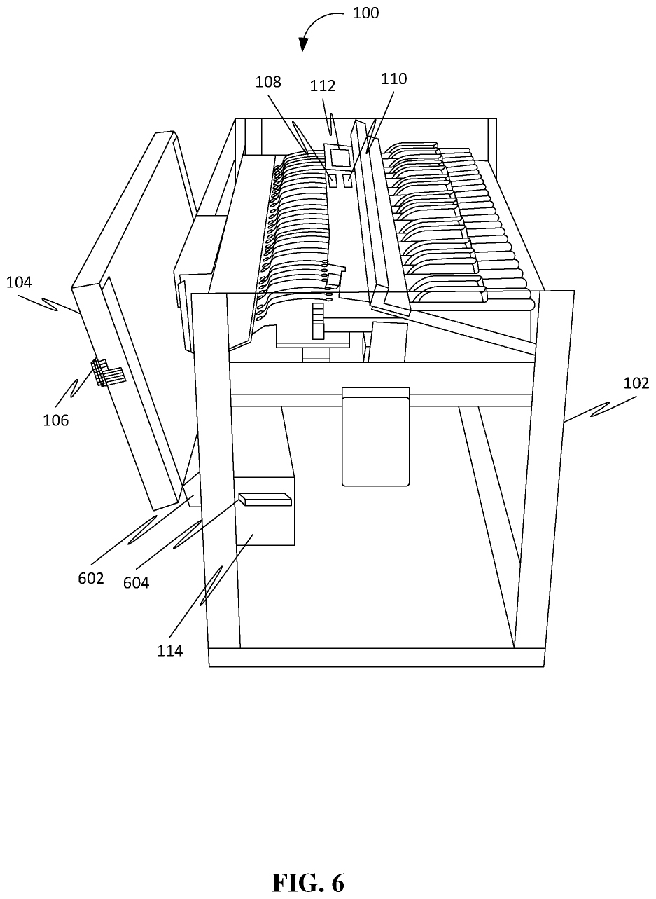

FIG. 6 is a left side top perspective view of the apparatus 100 with the one or more elastic elements 602 and the one or more elasticity control devices 604 of the one or more feedback output devices 114, in accordance with some embodiments. Further, the one or more feedback output devices 114 may include the one or more elastic elements 602 and the one or more elasticity control devices 604.

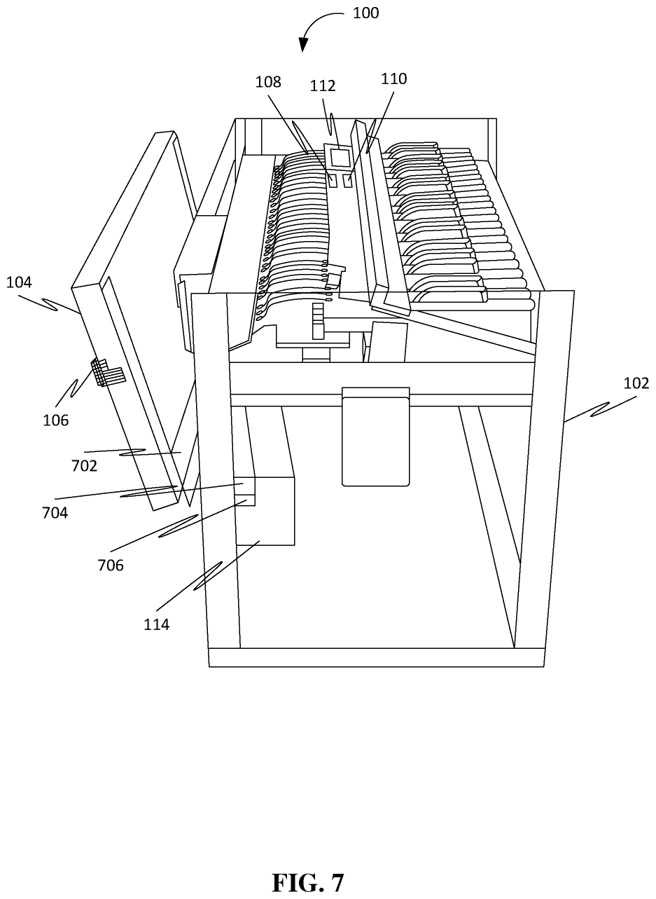

FIG. 7 is a left side top perspective view of the apparatus 100 with the one or more conductive elements 702, the one or more magnetic field sources 704, and the one or more control devices 706 of the one or more feedback output devices 114, in accordance with some embodiments. Further, the one or more feedback output devices 114 may include the one or more conductive elements 702, the one or more magnetic field sources 704, and the one or more control devices 706.

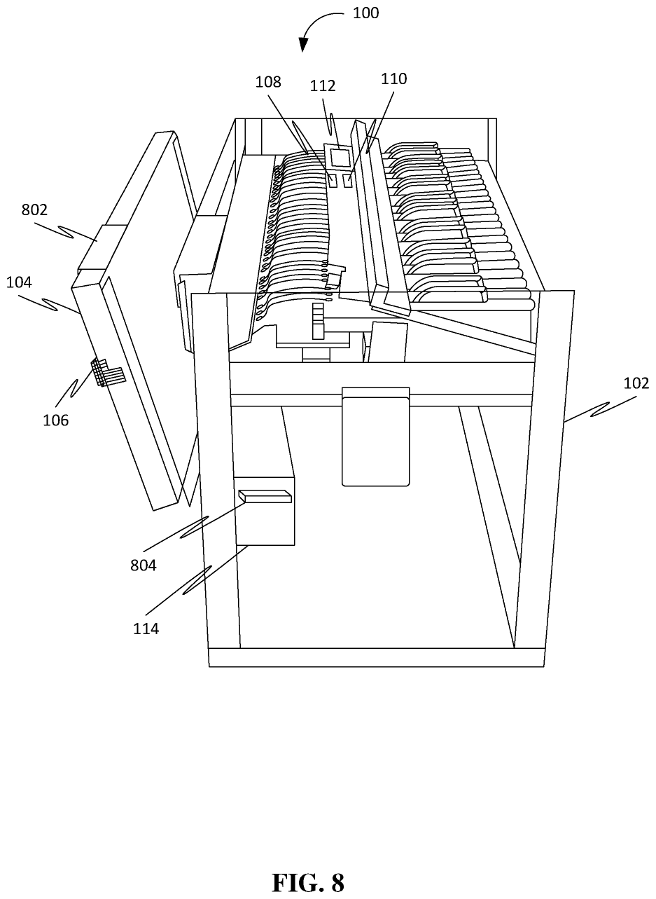

FIG. 8 is a left side top perspective view of the apparatus 100 with the one or more muscle stimulation electrodes 802 and the one or more stimulation control devices 804 of the one or more feedback output devices 114, in accordance with some embodiments. Further, the one or more feedback output devices 114 may include the one or more muscle stimulation electrodes 802 and the one or more stimulation control devices 804.

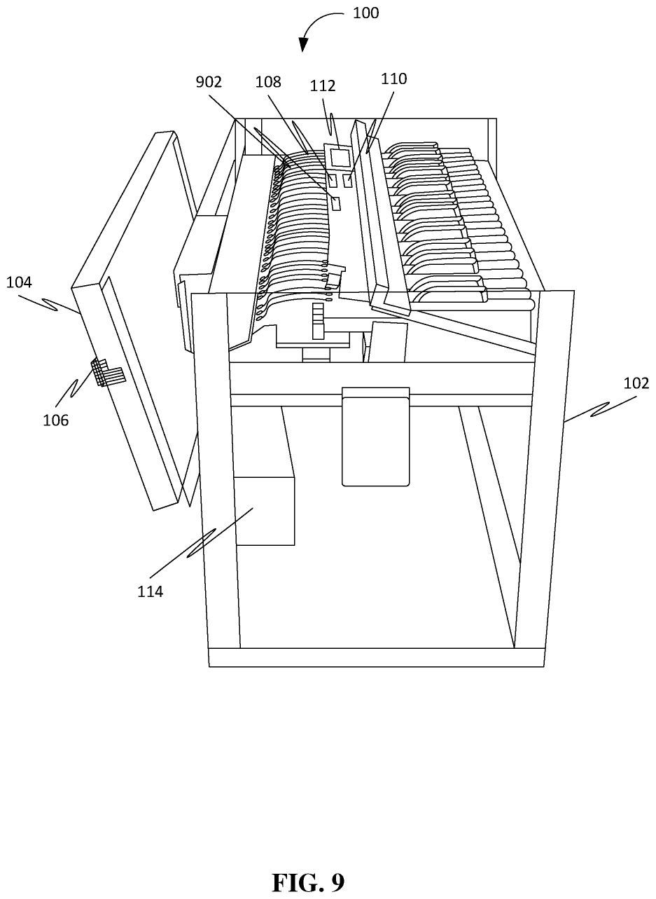

FIG. 9 is a left side top perspective view of the apparatus 100 with the one or more environment sensors 902, in accordance with some embodiments. Further, the apparatus 100 may include the one or more environment sensors 902.

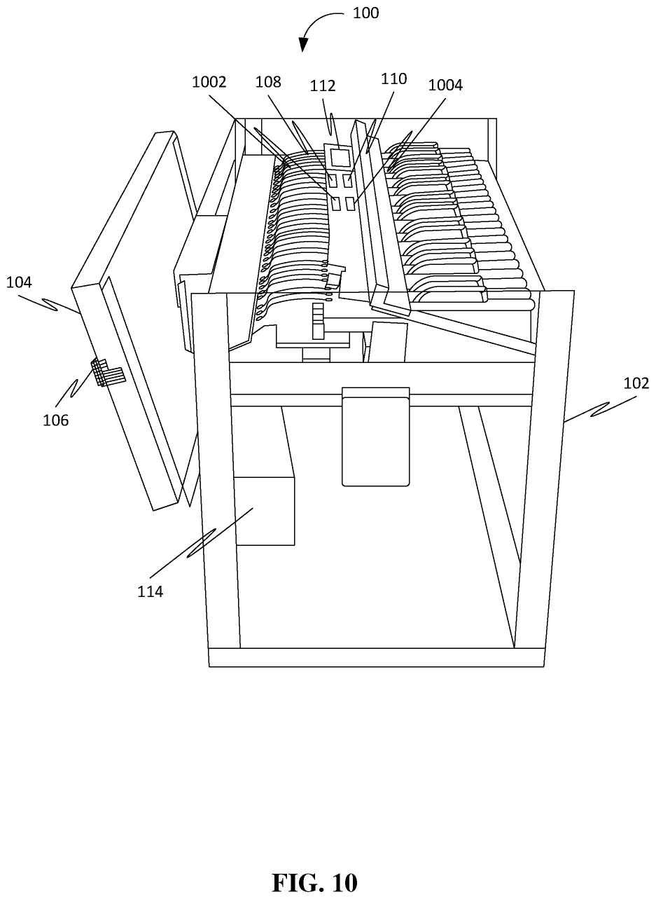

FIG. 10 is a left side top perspective view of the apparatus 100 with the user output device 1002 and the user input device 1004, in accordance with some embodiments. Further, the apparatus 100 may include the user output device 1002 and the user input device 1004.

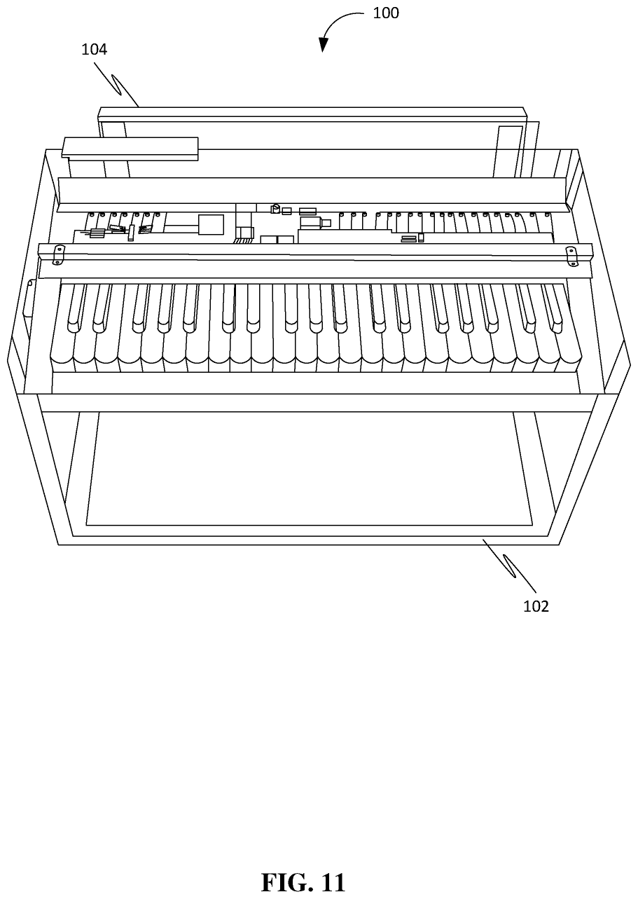

FIG. 11 is a top perspective view of the apparatus 100, in accordance with some embodiments. Further, the body 102 may be comprised of transparent material.

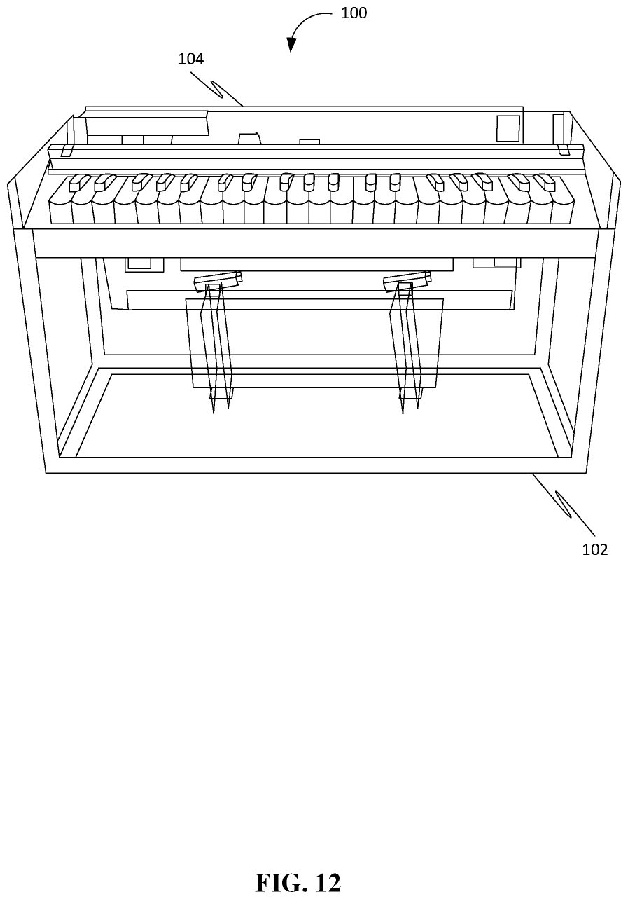

FIG. 12 is a front perspective view of the apparatus 100, in accordance with some embodiments. Further, the body 102 may include a keyboard.

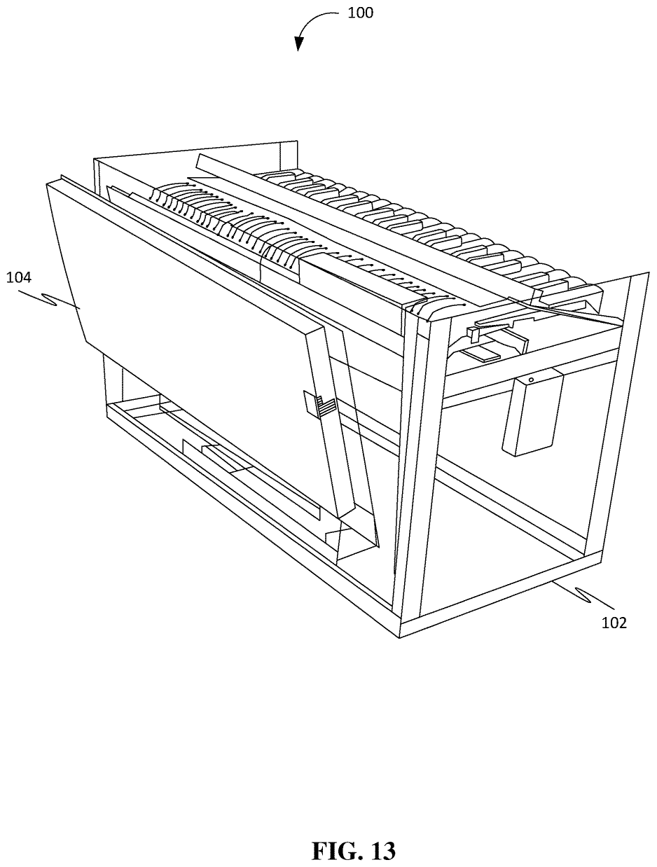

FIG. 13 is a rear left-side perspective view of the apparatus 100, in accordance with some embodiments. Further, the apparatus 100 may include the mechanical interface elements 104 movably coupled to the body 102.

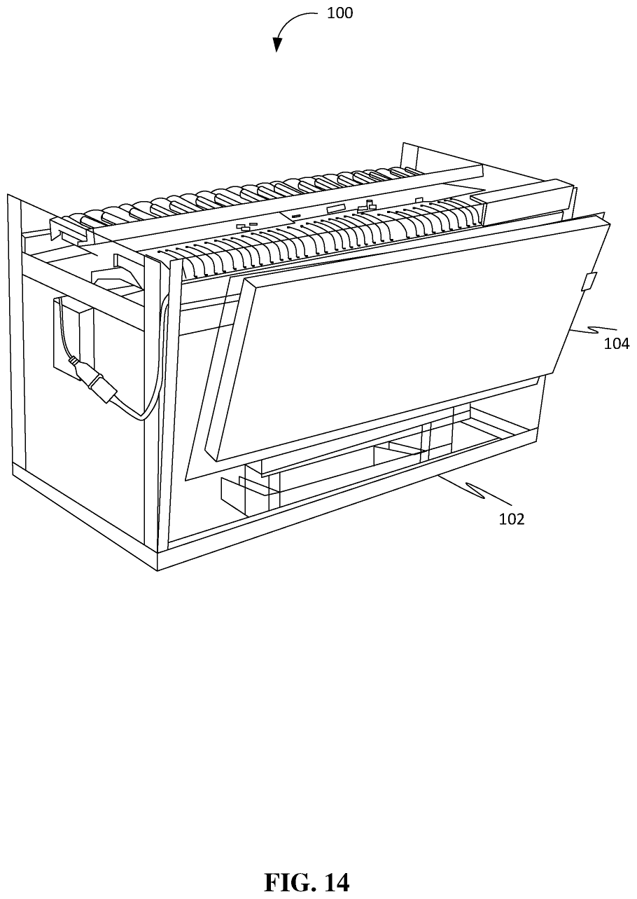

FIG. 14 is a rear right-side perspective view of the apparatus 100, in accordance with some embodiments. Further, the apparatus 100 may include the mechanical interface elements 104 movably coupled to the body 102 using a coupling element.

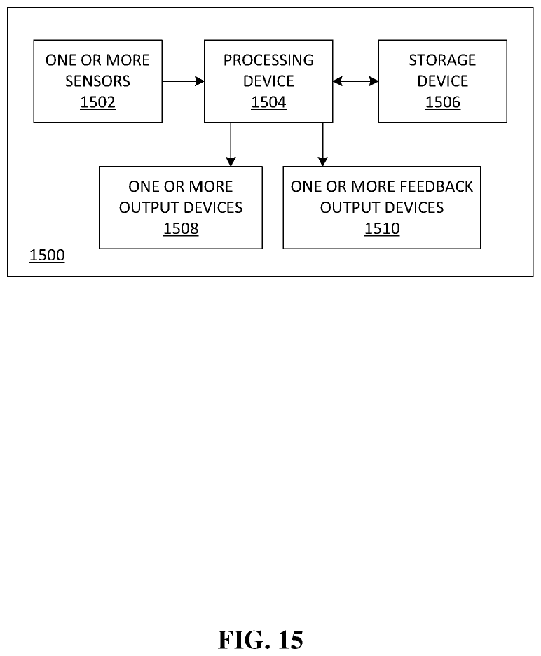

FIG. 15 is a block diagram of a device 1500 for producing musical sounds by simulating an experience of playing musical instruments, in accordance with some embodiments. Further, the device 1500 may include one or more sensors 1502, a processing device 1504, a storage device 1506, one or more output devices 1508, and one or more feedback output devices 1510. Further, the one or more sensors 1502, the storage device 1506, the one or more output devices 1508, and the one or more feedback output devices 1510 may be communicatively coupled with the processing device 1504.

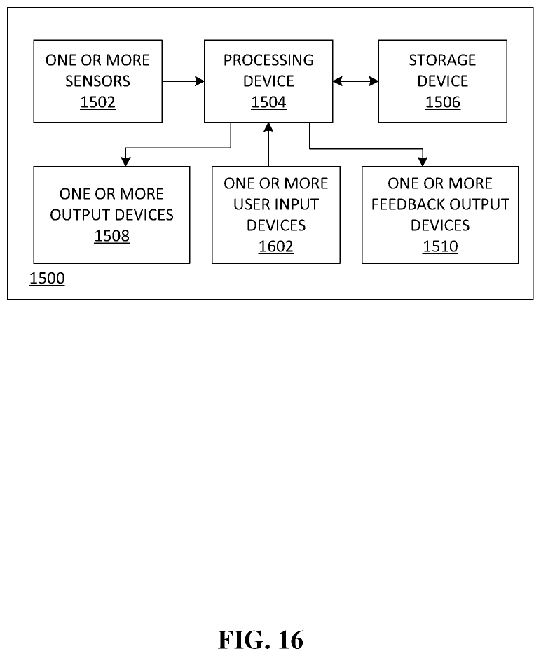

FIG. 16 is a block diagram of the device 1500 comprising one or more user input devices 1602, in accordance with some embodiments. Further, the one or more user input devices 1602 may be communicatively coupled with the processing device 1504.

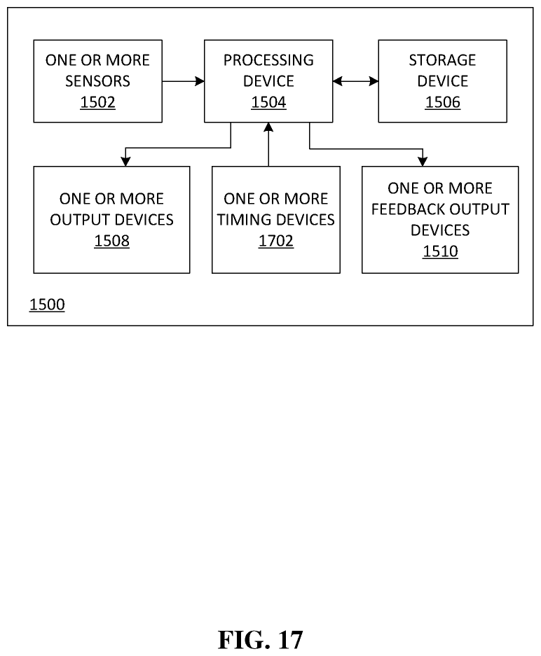

FIG. 17 is a block diagram of the device 1500 comprising one or more timing devices 1702, in accordance with some embodiments. Further, the one or more timing devices 1702 may be communicatively coupled with the processing device 1504.

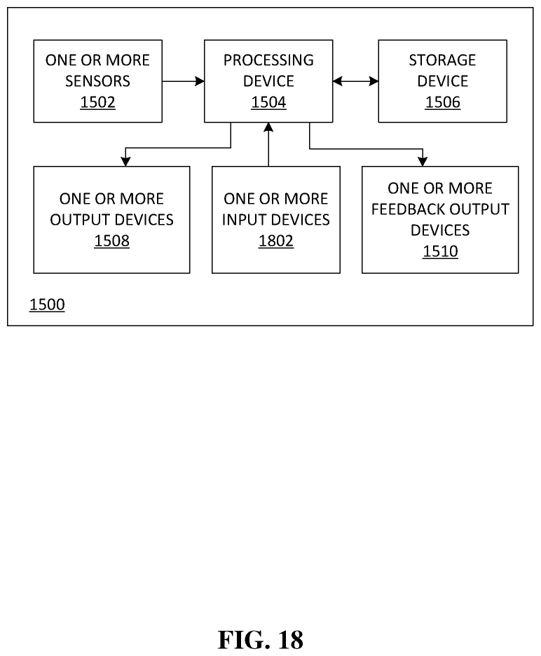

FIG. 18 is a block diagram of the device 1500 comprising one or more input devices 1802, in accordance with some embodiments. Further, the one or more input devices 1802 may be communicatively coupled with the processing device 1504.

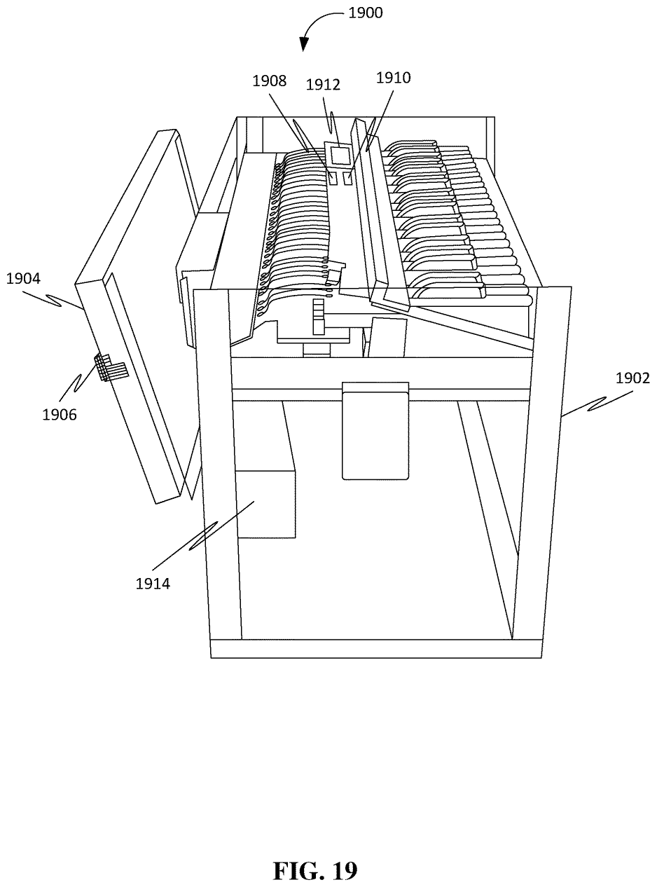

FIG. 19 is a left side top perspective view of an apparatus 1900 for producing musical sounds by simulating an experience of playing musical instruments, in accordance with some embodiments. Accordingly, the apparatus 1900 may include a body 1902, a mechanical interface element 1904, one or more sensors 1906, a processing device 1908, a storage device 1910, one or more output devices 1912, and one or more feedback output devices 1914.

Further, the mechanical interface element 1904 may be coupled to the body 1902. Further, the mechanical interface element 1904 may be configured to receive one or more user actions from a user. Further, the one or more sensors 1906 may be coupled to the body 1902. Further, the one or more sensors 1906 may be configured for detecting an operation associated with the mechanical interface element 1904. Further, the operation may be based on the one or more user actions received by the mechanical interface element 1904. Further, the processing device 1908 may be coupled to the body 1902. Further, the processing device 1908 may be communicatively coupled with the one or more sensors 1906. Further, the processing device 1908 may be configured for generating one or more sensor information based on the detecting of the operation. Further, the processing device 1908 may be configured for analyzing the one or more sensor information. Further, the processing device 1908 may be configured for analyzing one or more musical instrument information associated with a musical instrument. Further, the processing device 1908 may be configured for determining one or more values of one or more parameters associated with a musical sound production based on the analyzing of the one or more sensor information and the analyzing of the one or more musical instrument information. Further, the processing device 1908 may be configured for synthesizing one or more musical sounds based on the one or more values of the one or more parameters. Further, the processing device 1908 may be configured for determining a feedback for the operation based on the analyzing of the one or more sensor information and the one or more musical instrument information. Further, the storage device 1910 may be coupled to the body 1902. Further, the storage device 1910 may be communicatively coupled with the processing device 1908. Further, the storage device 1910 may be configured for storing the one or more musical instrument information associated with the musical instrument. Further, the one or more output devices 1912 may be coupled to the body 1902. Further, the one or more output devices 1912 may be communicatively coupled with the processing device 1908. Further, the one or more output devices 1912 may be configured for producing the one or more musical sounds based on the synthesizing of the one or more musical sounds. Further, the one or more feedback output devices 1914 may be coupled to the body 1902. Further, the one or more feedback output devices 1914 may be communicatively coupled with the processing device 1908. Further, the one or more feedback output devices 1914 may be configured for providing feedback to the user through the mechanical interface element 1904 based on the determining of the feedback. Further, the operation associated with the mechanical interface element 1904 may include a movement of the mechanical interface element 1904 in relation to the body 1902. Further, the feedback provided to the user may include a resistance opposing the movement of the mechanical interface element 1904. Further, the user applies the one or more user actions by performing the one or more user actions on the mechanical interface element 1904 using one or more hands of the user. Further, the resistance opposing the movement applies one or more counteractions on the one or more hands of the user during the performing of the one or more user actions.

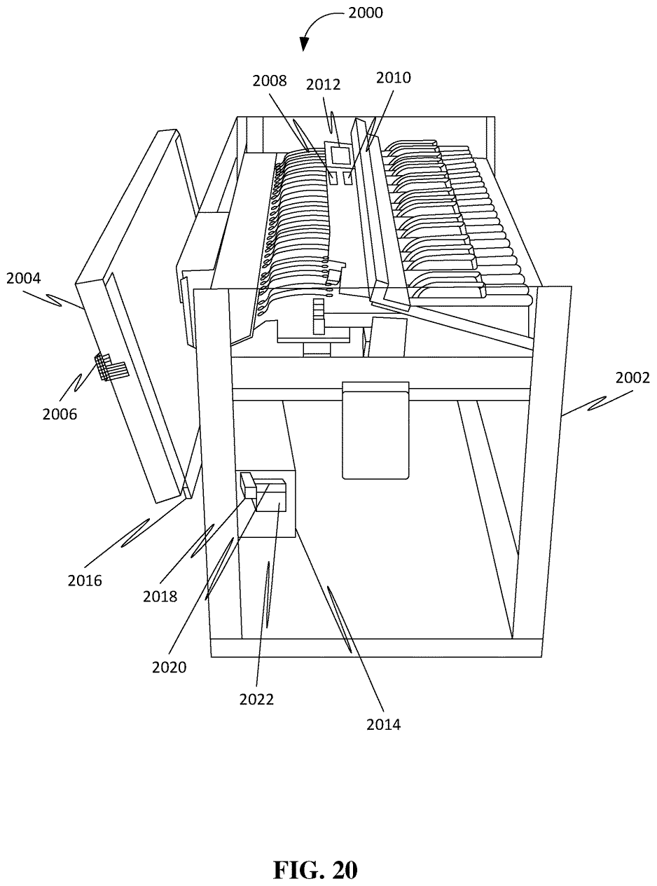

FIG. 20 is a left side top perspective view of an apparatus 2000 for producing musical sounds by simulating an experience of playing musical instruments, in accordance with some embodiments. Accordingly, the apparatus 2000 may include a body 2002, a mechanical interface element 2004, one or more sensors 2006, a processing device 2008, a storage device 2010, one or more output devices 2012, and one or more feedback output devices 2014.

Further, the mechanical interface element 2004 may be coupled to the body 2002. Further, the mechanical interface element 2004 may be configured to receive one or more user actions from a user. Further, the one or more sensors 2006 may be coupled to the body 2002. Further, the one or more sensors 2006 may be configured for detecting an operation associated with the mechanical interface element 2004. Further, the operation may be based on the one or more user actions received by the mechanical interface element 2004. Further, the processing device 2008 may be coupled to the body 2002. Further, the processing device 2008 may be communicatively coupled with the one or more sensors 2006. Further, the processing device 2008 may be configured for generating one or more sensor information based on the detecting of the operation. Further, the processing device 2008 may be configured for analyzing the one or more sensor information. Further, the processing device 2008 may be configured for analyzing one or more musical instrument information associated with a musical instrument. Further, the processing device 2008 may be configured for determining one or more values of one or more parameters associated with a musical sound production based on the analyzing of the one or more sensor information and the analyzing of the one or more musical instrument information. Further, the processing device 2008 may be configured for synthesizing one or more musical sounds based on the one or more values of the one or more parameters. Further, the processing device 2008 may be configured for determining a feedback for the operation based on the analyzing of the one or more sensor information and the one or more musical instrument information. Further, the storage device 2010 may be coupled to the body 2002. Further, the storage device 2010 may be communicatively coupled with the processing device 2008. Further, the storage device 2010 may be configured for storing the one or more musical instrument information associated with the musical instrument. Further, the one or more output devices 2012 may be coupled to the body 2002. Further, the one or more output devices 2012 may be communicatively coupled with the processing device 2008. Further, the one or more output devices 2012 may be configured for producing the one or more musical sounds based on the synthesizing of the one or more musical sounds. Further, the one or more feedback output devices 2014 may be coupled to the body 2002. Further, the one or more feedback output devices 2014 may be communicatively coupled with the processing device 2008. Further, the one or more feedback output devices 2014 may be configured for providing feedback to the user through the mechanical interface element 2004 based on the determining of the feedback. Further, the operation associated with the mechanical interface element 2004 may include a movement of the mechanical interface element 2004 in relation to the body 2002. Further, the feedback provided to the user may include a resistance opposing the movement of the mechanical interface element 2004. Further, the one or more feedback output devices 2014 comprise one or more first magnets 2016, one or more second magnets 2018, one or more actuators 2020, and a magnet control device 2022. Further, the one or more first magnets 2016 may be attached to one or more locations of the mechanical interface element 2004. Further, the one or more actuators 2020 may be coupled to the body 2002. Further, the one or more second magnets 2018 may be mechanically coupled to the one or more actuators 2020. Further, the magnet control device 2022 may be operatively coupled with the one or more actuators 2020. Further, the magnet control device 2022 may be communicatively coupled with the processing device 2008. Further, the magnet control device 2022 may be configured for generating one or more control signals for the one or more actuators 2020 based on the determining of the feedback. Further, the one or more actuators 2020 may be configured for transitioning the one or more second magnets 2018 to one or more of a position from a plurality of positions and an orientation from a plurality of orientations based on the one or more control signals. Further, the one or more second magnets 2018 magnetically interface with the one or more first magnets 2016 based on the movement of the mechanical interface element 2004. Further, one or more of the position and the orientation define a relative magnetic polarity and a relative generated magnetic force between the one or more second magnets 2018 and the one or more first magnets 2016 during the magnetic interfacing. Further, the resistance to the movement may be produced based on the relative magnetic polarity and the relative generated magnetic force.

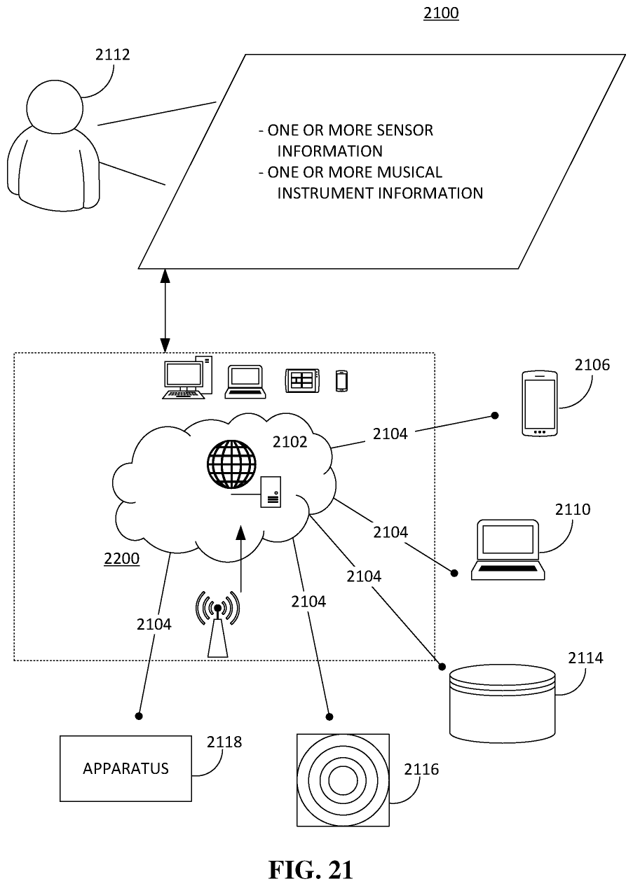

FIG. 21 is an illustration of an online platform 2100 consistent with various embodiments of the present disclosure. By way of non-limiting example, the online platform 2100 to facilitate producing of musical sounds by simulating an experience of playing musical instruments may be hosted on a centralized server 2102, such as, for example, a cloud computing service. The centralized server 2102 may communicate with other network entities, such as, for example, a mobile device 2106 (such as a smartphone, a laptop, a tablet computer, etc.), other electronic devices 2110 (such as desktop computers, server computers, etc.), databases 2114, sensors 2116, and an apparatus 2118 (such as the apparatus 100) over a communication network 2104, such as, but not limited to, the Internet. Further, users of the online platform 2100 may include relevant parties such as, but not limited to, end-users, administrators, service providers, service consumers, and so on. Accordingly, in some instances, electronic devices operated by the one or more relevant parties may be in communication with the platform.

A user 2112, such as the one or more relevant parties, may access online platform 2100 through a web based software application or browser. The web based software application may be embodied as, for example, but not be limited to, a website, a web application, a desktop application, and a mobile application compatible with a computing device 2200.

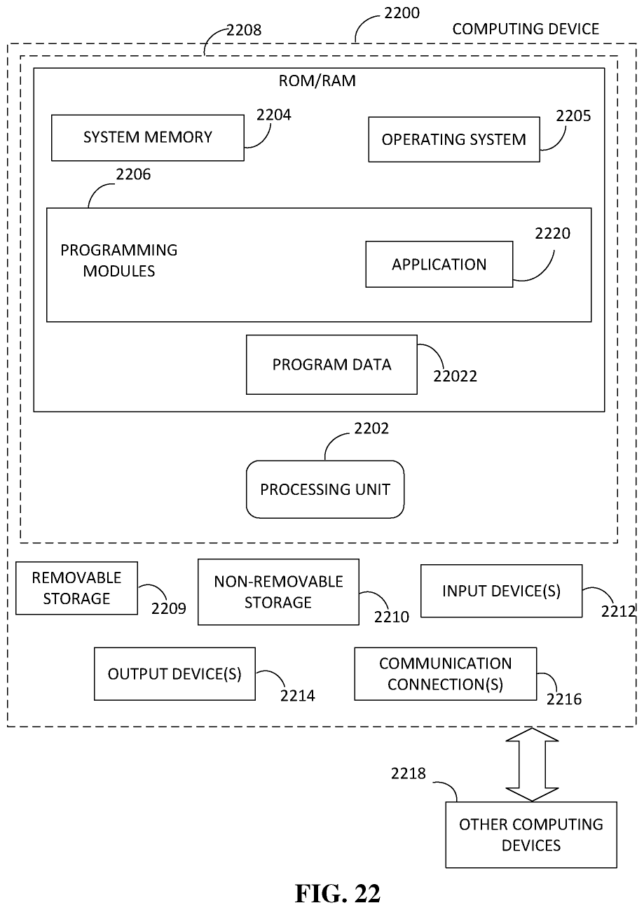

With reference to FIG. 22, a system consistent with an embodiment of the disclosure may include a computing device or cloud service, such as computing device 2200. In a basic configuration, computing device 2200 may include at least one processing unit 2202 and a system memory 2204. The at least one processing unit 2202 is a processor, a microprocessor, a microcontroller, a processing device, etc. Depending on the configuration and type of computing device, system memory 2204 may comprise, but is not limited to, volatile (e.g. random-access memory (RAM)), non-volatile (e.g. read-only memory (ROM)), flash memory, or any combination. The system memory 2204 is the storage device. System memory 2204 may include operating system 2205, one or more programming modules 2206, and may include a program data 2207. Operating system 2205, for example, may be suitable for controlling computing device 2200's operation. In one embodiment, programming modules 2206 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 22 by those components within a dashed line 2208.

Computing device 2200 may have additional features or functionality. For example, computing device 2200 may also include additional data storage devices (removable and/or non-removable) such as, for example, magnetic disks, optical disks, or tape. Such additional storage is illustrated in FIG. 22 by a removable storage 2209 and a non-removable storage 2210. Computer storage media may include volatile and non-volatile, removable, and non-removable media implemented in any method or technology for storage of information, such as computer-readable instructions, data structures, program modules, or other data. System memory 2204, removable storage 2209, and non-removable storage 2210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 2200. Any such computer storage media may be part of device 2200. Computing device 2200 may also have input device(s) 2212 such as a keyboard, a mouse, a pen, a sound input device, a touch input device, a location sensor, a camera, a biometric sensor, etc. Output device(s) 2214 such as a display, speakers, a printer, etc. may also be included. The aforementioned devices are examples and others may be used.

Computing device 2200 may also contain a communication connection 2216 that may allow device 2200 to communicate with other computing devices 2218, such as over a network in a distributed computing environment, for example, an intranet or the Internet. The communication connection 2216 is a communication interface, a network interface, a communication device, etc. Communication connection 2216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2204, including operating system 2205. While executing on processing unit 2202, programming modules 2206 (e.g., application 2220 such as a media player) may perform processes including, for example, one or more stages of methods, algorithms, systems, applications, servers, databases as described above. The aforementioned process is an example, and processing unit 2202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for producing musical sounds by simulating an experience of playing musical instruments, the apparatus comprising:
a body;
a mechanical interface element coupled to the body, wherein the mechanical interface element is configured to receive one or more user actions from a user;
one or more sensors coupled to the body, wherein the one or more sensors are configured for detecting an operation associated with the mechanical interface element, wherein the operation is based on the one or more user actions received by the mechanical interface element;
a processing device coupled to the body, wherein the processing device is communicatively coupled with the one or more sensors, wherein the processing device is configured for:
generating one or more sensor information based on the detecting of the operation;
analyzing the one or more sensor information;
analyzing one or more musical instrument information associated with a musical instrument;
determining one or more values of one or more parameters associated with a musical sound production based on the analyzing of the one or more sensor information and the analyzing of the one or more musical instrument information;
synthesizing one or more musical sounds based on the one or more values of the one or more parameters; and
determining a feedback for the operation based on the analyzing of the one or more sensor information and the one or more musical instrument information;
a storage device coupled to the body, wherein the storage device is communicatively coupled with the processing device, wherein the storage device is configured for storing the one or more musical instrument information associated with the musical instrument;
one or more output devices coupled to the body, wherein the one or more output devices are communicatively coupled with the processing device, wherein the one or more output devices are configured for producing the one or more musical sounds based on the synthesizing of the one or more musical sounds; and
one or more feedback output devices coupled to the body, wherein the one or more feedback output devices are communicatively coupled with the processing device, wherein the one or more feedback output devices are configured for providing feedback to the user through the mechanical interface element based on the determining of the feedback.

2. The apparatus of claim 1 further comprising:
one or more keys coupled to the body, wherein the one or more keys are configured to receive one or more key actions, wherein the one or more keys are associated with one or more reeds of the musical instrument; and
one or more input devices coupled to the body, wherein the one or more input devices are communicatively coupled with the processing device, wherein the one or more input devices are configured for generating one or more input information based on detecting a key action received on a key of the one or more keys, wherein the processing device is further configured for:
analyzing the one or more input information;
identifying the key based on the analyzing of the one or more input information, wherein the key is associated with a reed of the one or more reeds;
identifying a reed information associated with the reed based on the identifying of the key, wherein the reed information represents an acoustic model of a sound produced by the reed; and
analyzing the reed information, wherein the determining of the one or more values of the one or more parameters is further based on the analyzing of the reed information.

3. The apparatus of claim 1, wherein the processing device is further configured for:
determining one or more values of one or more operation parameters associated with the operation based on the analyzing of the one or more sensor information; and
determining one or more values of one or more airflow mechanism parameters associated with one or more airflow generating mechanisms of the musical instrument based on the one or more values of the one or more operation parameters, and the analyzing of the one or more musical instrument information, wherein the one or more airflow mechanism parameters are comprised in the one or more musical instrument information, wherein the determining of the one or more values of the one or more parameters is further based on the one or more values of the one or more airflow mechanism parameters.

4. The apparatus of claim 1 further comprising one or more user input devices disposed on the body, wherein the one or more user input devices are communicatively coupled with the processing device, wherein the one or more user input devices are configured for generating one or more user customization information for customizing the musical sound production, wherein the processing device is further configured for:
analyzing the one or more user customization information; and
determining one or more values of one or more airflow mechanism parameters associated with one or more airflow generating mechanisms of the musical instrument based on the analyzing of the one or more user customization information and the analyzing of the one or more musical instrument information, wherein the one or more airflow mechanism parameters are comprised in the one or more musical instrument information, wherein the determining of the one or more values of the one or more parameters is further based on the one or more values of the one or more airflow mechanism parameters.

5. The apparatus of claim 1 further comprising a timing device communicatively coupled with the processing device, wherein the timing device is configured for monitoring a time reference, wherein the processing device is configured for:
generating a time measurement based on the monitoring of the time reference; and
determining one or more values of one or more airflow mechanism parameters associated with one or more airflow generating mechanisms of the musical instrument based on the time measurement and the analyzing of the one or more musical instrument information, wherein the one or more airflow mechanism parameters are comprised in the one or more musical instrument information, wherein the determining of the one or more values of the one or more parameters is further based on the one or more values of the one or more airflow mechanism parameters.

6. The apparatus of claim 1, wherein the operation associated with the mechanical interface element comprises a movement of the mechanical interface element in relation to the body, wherein the feedback provided to the user comprises a resistance opposing the movement of the mechanical interface element.

7. The apparatus of claim 6, wherein the one or more feedback output devices comprise one or more first magnets, one or more second magnets, one or more actuators, and a magnet control device, wherein the one or more first magnets are attached to one or more locations of the mechanical interface element, wherein the one or more actuators are coupled to the body, wherein the one or more second magnets are mechanically coupled to the one or more actuators, wherein the magnet control device is operatively coupled with the one or more actuators, wherein the magnet control device is communicatively coupled with the processing device, wherein the magnet control device is configured for generating one or more control signals for the one or more actuators based on the determining of the feedback, wherein the one or more actuators are configured for transitioning the one or more second magnets to one or more of a position from a plurality of positions and an orientation from a plurality of orientations based on the one or more control signals, wherein the one or more second magnets magnetically interface with the one or more first magnets based on the movement of the mechanical interface element, wherein one or more of the position and the orientation define a relative magnetic polarity and a relative generated magnetic force between the one or more second magnets and the one or more first magnets during the magnetic interfacing, wherein the resistance to the movement is produced based on the relative magnetic polarity and the relative generated magnetic force.

8. The apparatus of claim 7, wherein the one or more feedback output devices further comprises one or more additional sensors communicatively coupled with the processing device, wherein the one or more additional sensors are further configured for:
detecting the one or more locations of the one or more first magnets; and
detecting one or more of a prior position and a prior orientation of the one or more second magnets, wherein the magnet control device is further configured for:
generating one or more location information of the one or more locations of the one or more first magnets based on the detecting of the one or more locations of the one or more first magnets;
generating one or more of a prior position information of the prior position, and a prior orientation information of the prior orientation of the one or more second magnets based on the detecting of one or more of the prior position and the prior orientation of the one or more second magnets;
analyzing the one or more location information and one or more of the prior position information and the prior orientation information based on the feedback; and
determining one or more of the position and the orientation based on the analyzing of the one or more location information and one or more of the prior position information and the prior orientation information, wherein the generating of the one or more control signals is further based on the determining of one or more of the position and the orientation.

9. The apparatus of claim 7, wherein the one or more first magnets are one or more permanent magnets, wherein the one or more second magnets are one or more electromagnets, wherein the magnet control device is operatively coupled with the one or more electromagnets, wherein the magnet control device is further configured for determining a required current direction and a required current magnitude for energizing the one or more electromagnets based on the feedback, wherein the generating of the one or more control signals is further based on the determining of the required current direction and the required current magnitude for energizing the one or more electromagnets, wherein the one or more feedback output devices further comprises an electromagnet driver operatively coupled with the magnet control device and the one or more electromagnets, wherein the electromagnet driver is configured for energizing the one or more electromagnets with the current having the required current direction and the required current magnitude based on the one or more control signals, wherein the one or more electromagnets further magnetically interface with the one or more permanent magnets based on the energizing of the one or more electromagnets, wherein the current having the required current direction and the required current magnitude further defines the relative magnetic polarity and the relative generated magnetic force between the one or more electromagnets and the one or more permanent magnets during the magnetic interfacing.

10. The apparatus of claim 6, wherein the one or more feedback output devices comprise one or more elastic elements and one or more elasticity control devices, wherein the mechanical interface element is connected to the body using the one or more elastic elements, wherein an elasticity of the one or more elastic elements is dynamically variable, wherein the one or more elasticity control devices are configured for generating one or more control signals based on the determining of the feedback, wherein the one or more elastic elements are configured for dynamically varying the elasticity of the one or more elastic elements to an elasticity value of a plurality of values based on the one or more control signals, wherein the providing of the feedback is based on the dynamically varying of the elasticity.

11. The apparatus of claim 6, wherein the one or more feedback output devices comprise one or more conductive elements, one or more magnetic field sources, and one or more control devices, wherein the one or more conductive elements are coupled to the mechanical interface element, and the one or more magnetic field sources are coupled to the body, wherein the one or more control devices are configured for generating one or more control signals based on the determining of the feedback, wherein the one or more magnetic field sources are configured for generating a magnetic field of one or more intensities for inducing a resistive force of one or more magnitudes to oppose the movement during an interaction of the one or more conductive elements with the magnetic field based on the one or more control signals and the movement of the mechanical interface element, wherein the providing of the feedback is further based on the generating of the magnetic field of the one or more intensities.

12. The apparatus of claim 6, wherein the user applies the one or more user actions by performing the one or more user actions on the mechanical interface element using one or more hands of the user, wherein the resistance opposing the movement applies one or more counteractions on the one or more hands of the user during the performing of the one or more user actions.

13. The apparatus of claim 12, wherein the one or more feedback output devices comprise one or more muscle stimulation electrodes and one or more stimulation control devices, wherein the one or more stimulation control devices are configured for generating one or more control signals based on the determining of the feedback, wherein the one or more muscle stimulation electrodes are configured for applying a stimulation of a value of a plurality of values to one or more muscles of the one or more hands based on the one or more control signals, wherein the providing of the feedback is further based on the applying of the stimulation of the value to the one or more muscles.

14. The apparatus of claim 1, wherein the one or more musical instrument information comprises a respective acoustic model for each of a plurality of instrument mechanisms of the musical instrument, wherein the plurality of instrument mechanisms comprises one or more airflow generating mechanisms, one or more sound generating mechanisms, and one or more sound modifying mechanisms, wherein each respective acoustic model comprises one or more mechanism parameters associated with a respective instrument mechanism, wherein the processing device is further configured for determining one or more values of the one or more mechanism parameters for one or more of the plurality of instrument mechanisms based on the analyzing of the one or more sensor information and the analyzing of the one or more musical instrument information, wherein the determining of the one or more values of the one or more parameters associated with the musical sound production is further based on the one or more values of the one or more mechanism parameters.

15. The apparatus of claim 14 further comprising one or more environment sensors communicatively coupled with the processing device, wherein the one or more environment sensors are configured for detecting one or more environmental musical sounds playing in an environment of the apparatus, wherein the processing device is further configured for:
generating one or more environmental musical sound information based on the detecting of the one or more environmental musical sounds;
analyzing the one or more environmental musical sound information; and
generating one or more customization information for customizing the musical sound production based on the analyzing of the one or more environmental musical sound information, and the analyzing of the one or more musical instrument information, wherein the determining of the one or more values of the one or more mechanism parameters for one or more of the plurality of instrument mechanisms is based on the one or more customization information.

16. The apparatus of claim 15, wherein the processing device is further configured for generating one or more recommendations for customizing the musical sound production based on the analyzing of the one or more environmental musical sound information and the analyzing of the one or more musical instrument information, wherein the apparatus further comprises a user output device communicatively coupled with the processing device, wherein the user output device is configured for presenting the one or more recommendations, wherein the apparatus further comprises a user input device communicatively coupled with the processing device, wherein the user input device is configured for receiving an input from the user, wherein the processing device is further configured for analyzing the input, wherein the generating of the one or more customization information is further based on the analyzing of the input.

17. The apparatus of claim 1, wherein the analyzing of the one or more musical instrument information comprises analyzing the one or more musical instrument information using one or more first machine learning models, wherein the one or more first machine learning models are configured for generating one or more first outputs, wherein the analyzing of the one or more sensor information comprises analyzing the one or more sensor information using one or more second machine learning models, wherein the one or more second machine learning models are connected with the one or more first machine learning models, wherein the one or more second machine learning models are configured for generating one or more second outputs based on the one or more first outputs, wherein the determining of the one or more values of the one or more parameters associated with the musical sound production is further based on the one or more second outputs.

18. The apparatus of claim 1, wherein the mechanical interface element replicates one or more of a form and a motion of a functional mechanical interface element of the musical instrument, wherein the mechanical interface element is non-functional.

19. An apparatus for producing musical sounds by simulating an experience of playing musical instruments, the apparatus comprising:
a body;
a mechanical interface element coupled to the body, wherein the mechanical interface element is configured to receive one or more user actions from a user;
one or more sensors coupled to the body, wherein the one or more sensors are configured for detecting an operation associated with the mechanical interface element, wherein the operation is based on the one or more user actions received by the mechanical interface element;
a processing device coupled to the body, wherein the processing device is communicatively coupled with the one or more sensors, wherein the processing device is configured for:
generating one or more sensor information based on the detecting of the operation;
analyzing the one or more sensor information;
analyzing one or more musical instrument information associated with a musical instrument;
determining one or more values of one or more parameters associated with a musical sound production based on the analyzing of the one or more sensor information and the analyzing of the one or more musical instrument information;
synthesizing one or more musical sounds based on the one or more values of the one or more parameters; and
determining a feedback for the operation based on the analyzing of the one or more sensor information and the one or more musical instrument information;
a storage device coupled to the body, wherein the storage device is communicatively coupled with the processing device, wherein the storage device is configured for storing the one or more musical instrument information associated with the musical instrument;
one or more output devices coupled to the body, wherein the one or more output devices are communicatively coupled with the processing device, wherein the one or more output devices are configured for producing the one or more musical sounds based on the synthesizing of the one or more musical sounds; and
one or more feedback output devices coupled to the body, wherein the one or more feedback output devices are communicatively coupled with the processing device, wherein the one or more feedback output devices are configured for providing feedback to the user through the mechanical interface element based on the determining of the feedback, wherein the operation associated with the mechanical interface element comprises a movement of the mechanical interface element in relation to the body, wherein the feedback provided to the user comprises a resistance opposing the movement of the mechanical interface element, wherein the user applies the one or more user actions by performing the one or more user actions on the mechanical interface element using one or more hands of the user, wherein the resistance opposing the movement applies one or more counteractions on the one or more hands of the user during the performing of the one or more user actions.

20. An apparatus for producing musical sounds by simulating an experience of playing musical instruments, the apparatus comprising:
a body;
a mechanical interface element coupled to the body, wherein the mechanical interface element is configured to receive one or more user actions from a user;
one or more sensors coupled to the body, wherein the one or more sensors are configured for detecting an operation associated with the mechanical interface element, wherein the operation is based on the one or more user actions received by the mechanical interface element;
a processing device coupled to the body, wherein the processing device is communicatively coupled with the one or more sensors, wherein the processing device is configured for:
generating one or more sensor information based on the detecting of the operation;
analyzing the one or more sensor information;
analyzing one or more musical instrument information associated with a musical instrument;
determining one or more values of one or more parameters associated with a musical sound production based on the analyzing of the one or more sensor information and the analyzing of the one or more musical instrument information;
synthesizing one or more musical sounds based on the one or more values of the one or more parameters; and
determining a feedback for the operation based on the analyzing of the one or more sensor information and the one or more musical instrument information;
a storage device coupled to the body, wherein the storage device is communicatively coupled with the processing device, wherein the storage device is configured for storing the one or more musical instrument information associated with the musical instrument;
one or more output devices coupled to the body, wherein the one or more output devices are communicatively coupled with the processing device, wherein the one or more output devices are configured for producing the one or more musical sounds based on the synthesizing of the one or more musical sounds; and
one or more feedback output devices coupled to the body, wherein the one or more feedback output devices are communicatively coupled with the processing device, wherein the one or more feedback output devices are configured for providing feedback to the user through the mechanical interface element based on the determining of the feedback, wherein the operation associated with the mechanical interface element comprises a movement of the mechanical interface element in relation to the body, wherein the feedback provided to the user comprises a resistance opposing the movement of the mechanical interface element, wherein the one or more feedback output devices comprise one or more first magnets, one or more second magnets, one or more actuators, and a magnet control device, wherein the one or more first magnets are attached to one or more locations of the mechanical interface element, wherein the one or more actuators are coupled to the body, wherein the one or more second magnets are mechanically coupled to the one or more actuators, wherein the magnet control device is operatively coupled with the one or more actuators, wherein the magnet control device is communicatively coupled with the processing device, wherein the magnet control device is configured for generating one or more control signals for the one or more actuators based on the determining of the feedback, wherein the one or more actuators are configured for transitioning the one or more second magnets to one or more of a position from a plurality of positions and an orientation from a plurality of orientations based on the one or more control signals, wherein the one or more second magnets magnetically interface with the one or more first magnets based on the movement of the mechanical interface element, wherein one or more of the position and the orientation define a relative magnetic polarity and a relative generated magnetic force between the one or more second magnets and the one or more first magnets during the magnetic interfacing, wherein the resistance to the movement is produced based on the relative magnetic polarity and the relative generated magnetic force.
